(19) United States
(12) Patent Application Publication
(10) Pub. No.: US 2013/0288781 A1
(43) Pub. Date: Oct. 31, 2013

(54) System And Method For Product-Based Gaming

(71) Applicant: Mahoot, Inc., Palo Alto, CA (US)

(72) Inventors: Randi Kofman, Lafayette, CA (US); Linda Hirschhorn Pouliot, San Mateo, CA (US); Evan John Gridley, Sunnyvale, CA (US)

(73) Assignee: Mahoot, Inc., Palo Alto, CA (US)

(21) Appl. No.: 13/902,668

(22) Filed: May 24, 2013

Related U.S. Application Data
(63) Continuation-in-part of application No. 13/673,907, filed on Nov. 9, 2012.
Application No. 13/673,907 is a continuation-in-part of application No. 13/293,020, filed on Nov. 9, 2011.
(60) Provisional application No. 61/557,782, filed on Nov. 9, 2011.
(60) Provisional application No. 61/493,357, filed on Jun. 3, 2011.

(51) Int. Cl. A63F 13/00

(52) U.S. Cl. CPC A63F 13/00
USPC 463/25

(57) ABSTRACT

Disclosed are new approaches for providing a product based game. A host may receive a user selection of one or more products. Products may be selected by scanning optical codes using a camera or other device. According to an outcome of the game, one or both of a product and a promotional offer are selected, including discounts and these are communicated to the user. Graphical representations of the one or more products selected by the user may be used as interface elements in a game interface. In some embodiments, a multi-player game may be initiated from a social networking interface and invitations issued to users linked to an inviter's networking interface. A player may pay a fee to buy points or for the privilege of playing. In some embodiments, the promotional offer is a discount and the discount amount is at least as great as a game fee.

### RELATED APPLICATIONS

This application is a continuation-in-part of U.S. application Ser. No. 13/673,907, filed Nov. 9, 2012, and entitled SYSTEM AND METHOD FOR PRODUCT-BASED GAMING, which claims priority to U.S. Provisional Application Ser. No. 61/557,782, filed Nov. 9, 2011, and entitled ONLINE SHOPPING/GAMING, both of which are hereby incorporated herein by reference in their entirety.

This application is also a continuation-in-part of U.S. application Ser. No. 13/293,020, filed Nov. 9, 2011, and entitled ONLINE SHOPPING/GAMING, which claims priority to U.S. Provisional Application Ser. No. 61/493,357, filed Jun. 3, 2011, and entitled ONLINE SHOPPING/GAMING, both of which applications are hereby incorporated herein by reference in their entirety.

### BACKGROUND

The internet has become a primary resource for entertainment. Many popular sites offset internet-based games and videos. Typically such sites are advertisement supports or require payment of a subscription fee. However, banner ads and other forms of advertisements displayed in a browser are easily ignored. Accordingly, the “click-through” rate for such advertisements is extremely low.

Many people also use the internet for shopping including both purchasing products from websites and researching products they wish to buy. The abundance of shopping sites makes it difficult to attract customers. In addition, the browsing habits of many users include only looking at a merchant's website for a matter of seconds before moving on to another site or navigating to another portion of a merchant's website.

In view of the foregoing it would be an advancement in the art to provide an approach to internet shopping and advertising that is able to attract customer's attention as well as providing the entertainment that many internet users seek.

### DESCRIPTION OF THE DRAWINGS

The specific features, aspects and advantages of the present invention will become better understood with regard to the following description and accompanying drawings where:

FIG. 1. is a schematic block diagram of a computing device suitable for use in accordance with an embodiment of the present invention;

FIG. 2. is a schematic block diagram of a networking environment suitable for use in accordance with an embodiment of the present invention;

FIG. 3. is a process flow diagram method for providing a product-based game in accordance with an embodiment of the present invention;

FIG. 4. is a schematic block diagram of a network profile interface suitable for launching a product based game in accordance with an embodiment of the present invention;

FIG. 5. is a process flow diagram of a method for providing a product-based game in the context of a social networking system in accordance with an embodiment of the present invention;

FIG. 6. is a process flow diagram of a method for interfacing a product-based game with a merchant providing products for use in the product-based game in accordance with an embodiment of the present invention;

FIGS. 7A and 7B are illustrations of interfaces for a product-based game in accordance with an embodiment of the present invention;

FIG. 8. is a process flow diagram of a method for setting up a product-based game in accordance with an embodiment of the present invention;

FIG. 9. is a process flow diagram of a method for joining a product-based game in accordance with an embodiment of the present invention;

FIG. 10. is a process flow diagram of a method for initiating a product-based game interface in accordance with an embodiment of the present invention;

FIG. 11. is a process flow diagram of a method for managing player interactions in a product-based game in accordance with an embodiment of the present invention;

FIG. 12. is a process flow diagram of a method for managing a player's turn in a product-based game in accordance with an embodiment of the present invention;

FIG. 13. is a process flow diagram of a method for managing exchange of products in a product-based game in accordance with an embodiment of the present invention;

FIG. 14. is a process flow diagram of a method for holding a product in a product-based game in accordance with an embodiment of the present invention; and

FIG. 15. is a process flow diagram for presenting and redeeming product discounts in a product-based game in accordance with an embodiment of the present invention.

FIG. 16. is a process flow diagram for performing a branded product-based game in accordance with an embodiment of the present invention.

FIG. 17. is a process flow diagram for awarding promotions for participation in product-based games in accordance with an embodiment of the present invention.

FIG. 18. is a process flow diagram of a memory game suitable for use in a product-based game in accordance with an embodiment of the present invention.

FIG. 19. is a process flow diagram of a domino type game suitable for use in accordance with an embodiment of the present invention.

FIG. 20. is a diagram of tiles played in a domino type game in accordance with an embodiment of the present invention.

FIG. 21. is process flow diagram of a method for providing a product-based game using user responses to characterize customer awareness in accordance with an embodiment of the present invention.

FIG. 22. is a process flow diagram of an alternative method for providing a product-based game using user responses to characterize customer awareness in accordance with an embodiment of the present invention.

FIG. 23. is a process flow diagram of a method for providing a product-based game including image-to-text and text-to-image responses in accordance with an embodiment of the present invention.

FIG. 24. is a process flow diagram of a method for providing a product-based knowledge gram in accordance with an embodiment of the present invention.

FIG. 25. is a process flow diagram of a method for providing a product-based game integrated with social media content in accordance with an embodiment of the present invention.

FIG. 26. is a process flow diagram of a method for integrating games and content from various authors into a product-based gaming system.

FIG. 27. is a process flow diagram of a method for providing a musical product-based game in accordance with an embodiment of the present invention.

FIG. 28. is a process flow diagram of a method for providing a pricing product-based game in accordance with an embodiment of the present invention.

### DETAILED DESCRIPTION OF THE PREFERRED EMBODIMENT

In the following description of the preferred embodiment of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

In the following description, numerous specific details are set forth in order to provide a thorough understanding of the present invention. However, it will be apparent to one skilled in the art that the present invention can be practiced without these specific details. In other instances, well known circuits, components, algorithms, and processes have not been shown in detail or have been illustrated in schematic or block diagram form in order not to obscure the present invention in unnecessary detail. Additionally, for the most part, details concerning networks, interfaces, computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The following description relates to methods for providing product-based gaming. A user may select a product or products and may also provide a ranking of a list of products. The products may be selected by scanning optical codes, such as by means of a camera provided on a smart phone or other portable computing device. A host receives the selection of a product or products and possibly a ranking. The host then manages interaction with the user to provide game play. According to an outcome of the game, the host selects one or both of a product and a promotion, which may include a discount amount, and presents one or both of these to the player. In some embodiments, images of the one or more products selected by the user are used as interface elements in the game. The player may pay a fee to play the game and the promotion may include a discount amount chosen to be at least as great as the fee. Upon redemption of the promotion, a merchant may pay a fee to an entity providing the product-based game.

Various additional features and alternative embodiments are disclosed herein, including various games suitable for use in accordance with the disclosed systems and methods

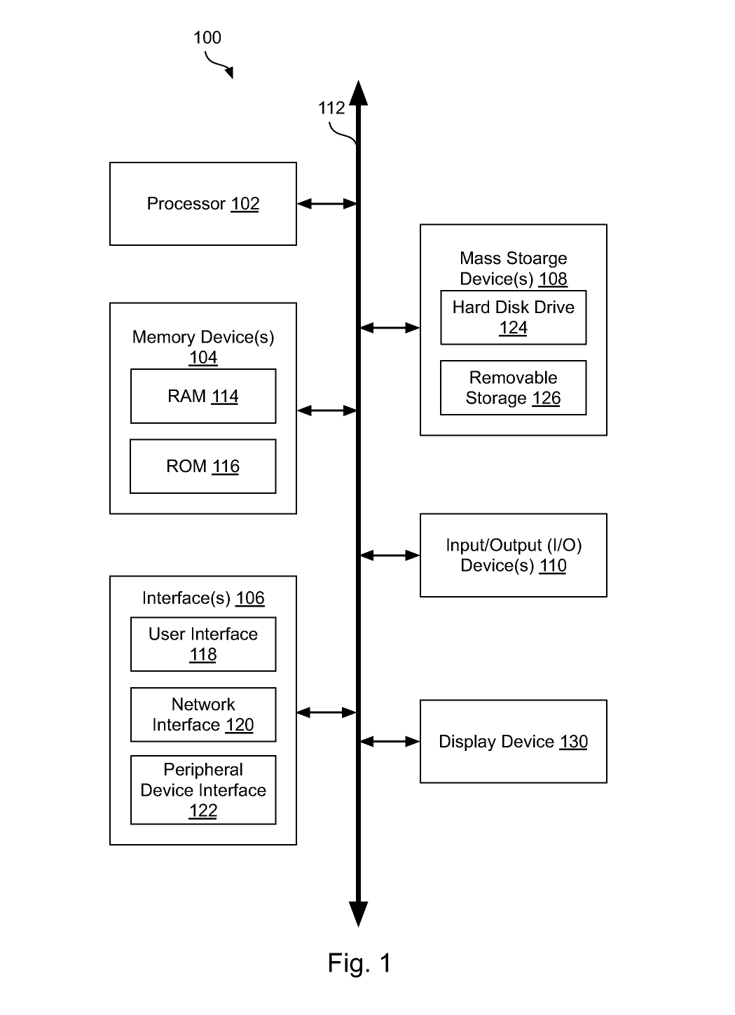

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

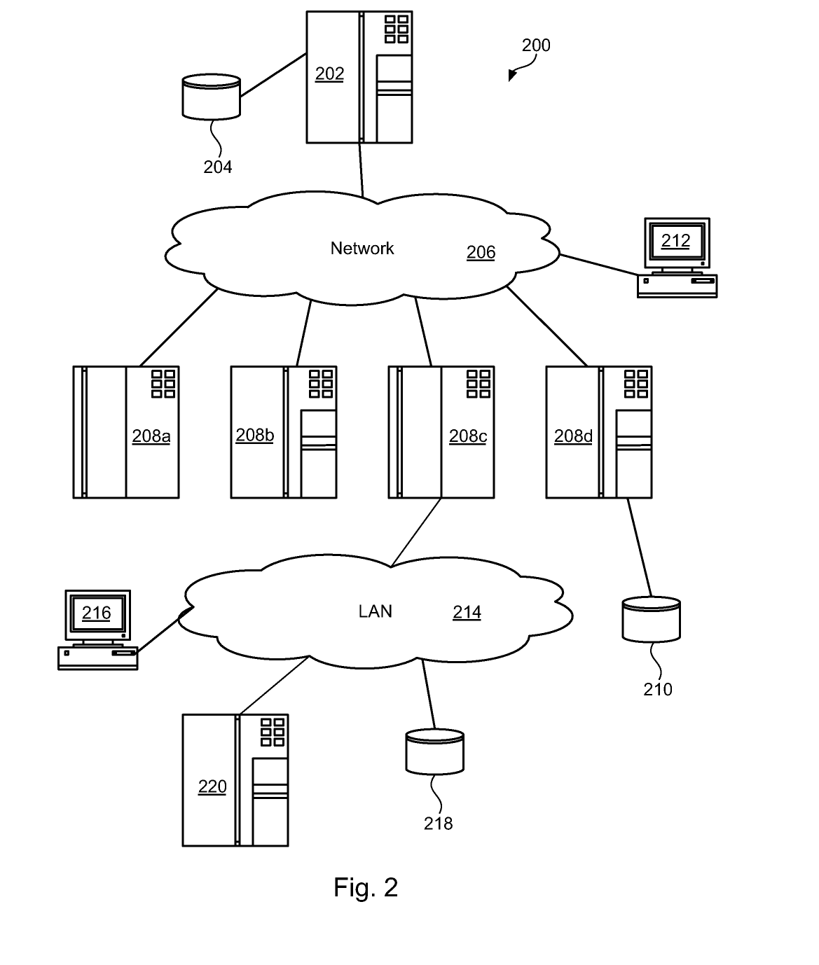

FIG. 2 is a block diagram illustrating an example operating environment 200, including a host server 202 operably coupled to a build database 204. The host server 202 and other components of the environment 200 may be embodied as the computing device 100 and include some or all of the components illustrated in FIG. 1. The database 204 may be a memory device, such as a hard drive, operably coupled to the host server 202 or may be another computing device 100 communicatively coupled to the host server 202. The host server 202 may be coupled to a network 206 such as a LAN, WAN, or the Internet. One or more additional servers 208a-208d may also be operably coupled to the network 206. The servers 208a-208d may host build systems or may provide application subscription services as described herein below. The servers 208a-208d may also provide other services including custom services programmed by an end user. In some embodiments, the host server 202 may also provide an application subscription service as described herein below. One or more of the servers 208a-208d may be operably coupled to a database 210 to facilitate provision of an application subscription service.

One or more workstations 212 may be operably coupled to the host server 202 or one or more of the servers 208a-208d, such as by means of the network 206. The workstation 212 may be used by a user wishing to access the services provided by the servers 208a-208d or host server 202. The workstation 212 may host a browser for presenting a web-based interface to processes running on the servers 208a-208d or host server 202. The workstation 212 may be embodied as a computing device such as that illustrated in FIG. 1. The workstation 212 may be a desktop, laptop, or tablet computer. The workstation 212 may also be embodied as a smart phone, tablet computer, or other portable computing device.

One or more of the servers 208a-208d may be coupled to a local area network (LAN) 214 having one or more of additional workstations 216, databases 218, and servers 220. In such embodiments, the server 208c coupled to the LAN may provide a gateway to a system seeking to access resources provided on the workstation 216, database 218, or server 220. Accordingly, the services “provided” by the server 208c may include those provided components coupled to the LAN 214 and accessed by means of the server 208c.

In some embodiments, the host server 202 may provide product-based gaming for users on one or more workstations 212. The servers 208a-208d may provide internet purchasing interfaces for users wishing to purchase products featured in a product-based game provided by the host server. For purposes of this disclosure a “product” may be anything that may be purchased with money including goods, services, and any and all intangible property.

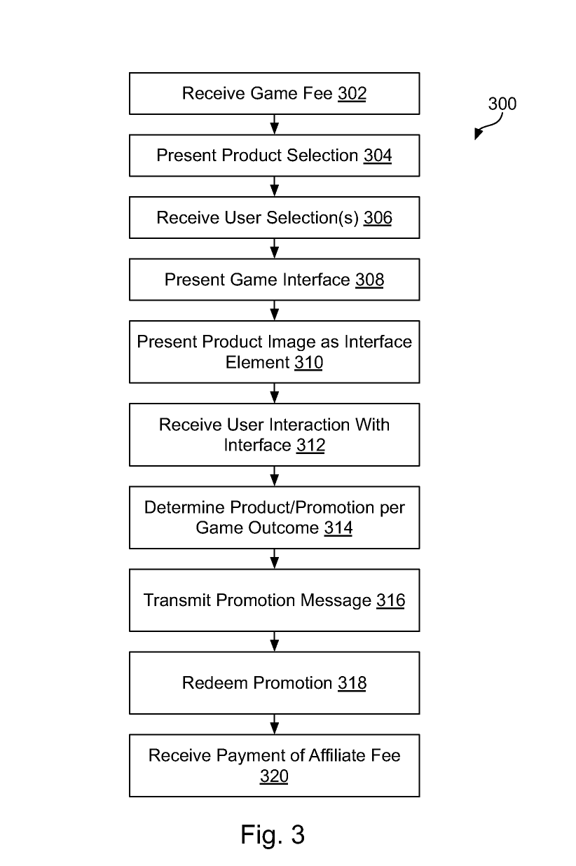

FIG. 3 illustrates a method 300 for providing product-based gaming suitable for the operating environment 300. The method may include receiving 302 a game fee from one or more prospective players. Receiving 302 the game fee may be performed by a financial institution or the like and may include transmitting a verification of receipt of the game fee to the host server 202. The game fee may be very small and in some embodiments, the fee may be omitted entirely or omitted during a trial period of the gaming system described herein.

A prospective player may also be presented 304 with a product selection on the workstation 212. The product selection may include products from one or more merchants and may be navigable and searchable as known in the art of online shopping. Presenting 304 may include presenting 304 the product selection in a web browser or embedded in a game interface. The products may be represented with images and/or text and may be presented with additional information such as customer reviews and links to related products. The prospective player chooses products from the product selection and these choices are transmitted to the host server 202. The host server receives 306 the prospective player's choices, in the form of product identifiers for the selected products. In some embodiments, prospective players may rank multiple products in order of preference. Accordingly, receiving 306 the prospective player's choices may include receiving a ranking for the products chosen.

In some embodiments, a user does not select products and is not presented with an opportunity to select products. For example, a user may simply be presented with an invitation to play a game for the opportunity to win a promotion, such as a discount, for a pre-determined product.

The host server 202 may then present 308 a game interface to one or more prospective players. The game interface may be a locally executed application. In such embodiments, presenting 308 the game interface may include transmitting an authorization or instruction to the local interface to present the game interface upon payment of the game fee and selection of one or more products. Alternatively, the game interface may be a web-based interface such that presenting 308 the game interface may include transmitting a web page operable to provide a game interface when rendered by a browser. Presenting 308 the game interface may include presenting 310 images of one or more produces selected by a player as interface elements. For example, game pieces, buttons, and other elements that a user may manipulate using a mouse may be displayed on the user workstation with an image of a selected product.

The game interface receives 312 user interactions therewith. For web based applications, receiving 312 user interactions may include receiving 312 these interactions at the host server 202 as transmitted from a web-based application or browser executing on the workstation 212. The host server 202 may interpret the user interactions and update the state of the game and transmit any updates to the game interface to the user workstation 212. For locally executing, applications, the locally executing application receives 312 the user interactions and updates the state of the locally executing game and locally presented game interface as necessary.

Upon conclusion of the game, the method 300 includes determining 314 which product and/or promotion or discount the player receives according to the outcome of the game. In some embodiments, the discount is fixed and the product is selected according to the outcome of the game. In some embodiments, an awarded promotion may include buy one, get one deals, gifts with purchase of a prize product, access to limited supply goods, access to events, access to special content, and the like. In other embodiments, the product is always one of the products selected by the player but the amount of the discount or type of promotion depends on the outcome of the game. In still other embodiments, the product and the promotion, such as a discount amount, are selected based on the outcome of the game. In embodiments where a fee is paid to play the game, the value of the promotion or amount of the discount is preferably greater than or equal to the amount of the game fee. In some embodiments, the product and/or promotion are selected by a random process where the likelihood of receiving one of the products selected by the player and/or a larger valued promotion, e.g., discount amount, increases based on the outcome of the game, i.e., number of points, win or loss, completion of a task, or the like. In embodiments, where users select products and rank them in terms of desirability, the likelihood that the user will receive a promotion, such as a discount, for a higher ranked product may increase based on the outcome of the game. For example, a larger number of points may increase the likelihood of getting a higher ranked product. The step of determining 314 the prize product and/or promotion may be performed by the host server 202 or by an application executing on the workstation 212.

A promotion message may then be transmitted 316 to the player, such as by transmitting a message to the workstation 212 by means of a web browser, email application, text message, or interaction with another locally executing application on the workstation 212. The promotion message may identify the prize product determined at step 314 and the promotion, such as a discount amount. The promotion message may further include a time limiter indicating how long the promotion will be available or providing other incentives to redeem the promotion in a timely manner. Other incentives may include promotions for accessories for the prize product that expire if not redeemed by a given time or an additional discount for the prize product that expires unless the promotion is redeemed by a given time. In addition to any incentives, offers, advertisements, and discounts, or other promotions for other products, which may relate to the prize product, may also be included in the promotion message. The promotion message may include a promotional code, electronic coupon, or other data enabling the player to redeem the promotion for the prize product at a website or physical store of a merchant.

Upon redemption of the promotion for the prize product by the player, the merchant that sold the product to the player may remit an affiliate fee or other compensation to the entity owning or controlling the host server 202. Accordingly the method 300 may include receiving 320 payment of an affiliate fee. The fee may be paid to a financial institution such that receiving 320 payment of the affiliate fee may include receiving 320 notice of payment of the affiliate fee. In some embodiments, a merchant providing products for selection using the method 300 may pay a sponsorship fee such that payment of an affiliate fee upon redemption of a promotion message is not performed.

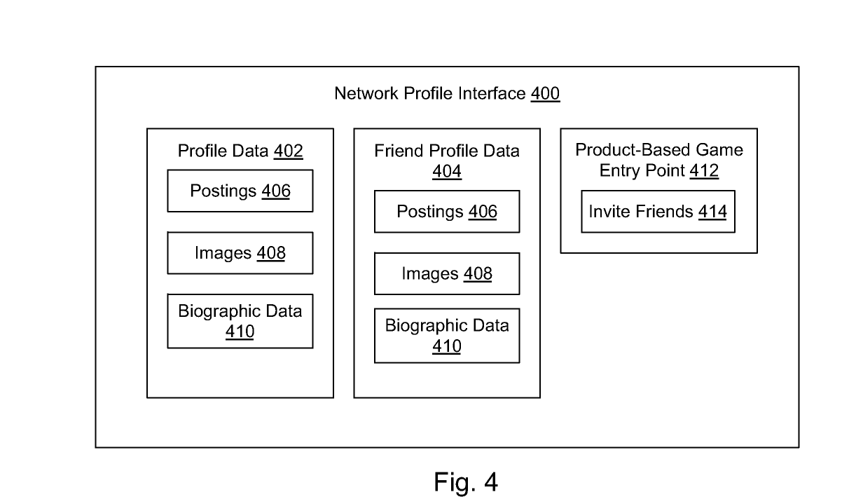

FIG. 4 illustrates a network profile interface 400 that may be used for launching a product-based game as described above with respect to FIG. 3. The network profile interface 400 may be an interface to a social or professional networking site such as Facebook, Linkedin, Myspace, Twitter, or the like. The network profile interface 400 may be presented in a browser and may reflect data stored in a database accessed by means of a server, such as one of the servers 208a-208d. The network profile interface 400 may display profile data 402 for a user profile data 404 for one or more friends linked to the user's profile. The profile data 402, 404 may include postings 406 of text, images 408, and other biographic data 410.

The network profile interface 400 may additionally display an entry point 412 to launch a product-based game, such as described above with respect to FIG. 3. The entry point 412 may be a hypertext link, linked image, button, or other user interface element. The entry point 412 may include an interface element 414 allowing a user to invite friends, such as friends having their profile data 404 linked to the user's profile data 402 to join in a product-based game.

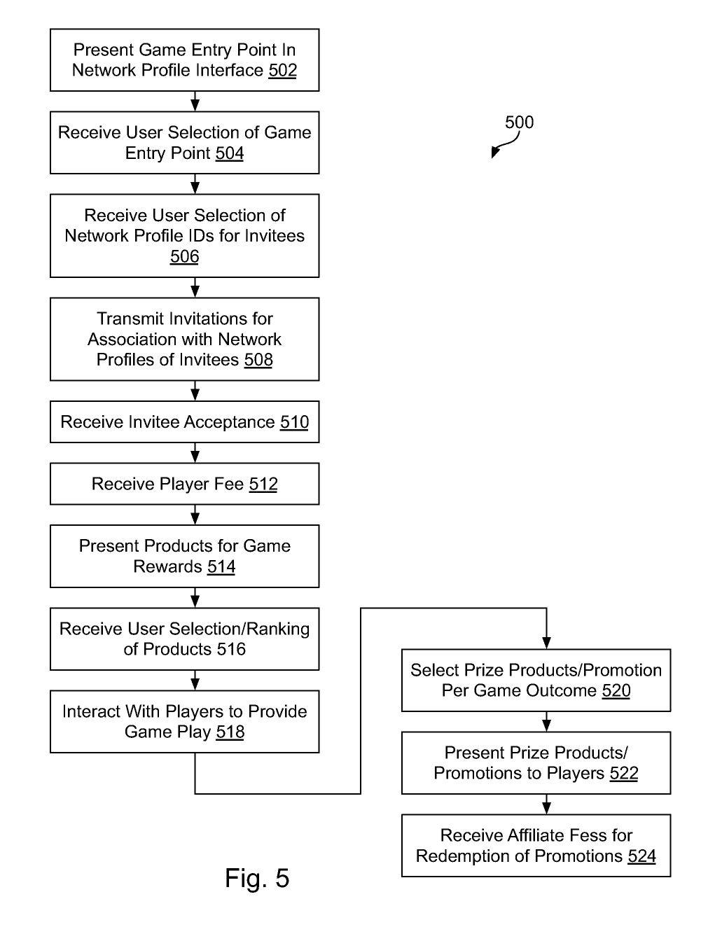

FIG. 5 illustrates a method 500 for initiating and managing a product-based game using a network profile interface 400. The method 500 may include displaying 502 an entry point 412 for a product based game in a network profile interface 400 of a prospective player. The entry point may be a button, link, or any other user interface element. The entry point may be linked to a host server 202 such that interaction by a user with the entry point instructs the host server to take actions necessary to initiate a product based game. In some embodiments, the method 500 may also be executing using a social networking interface. Other network interfaces such as email and the like may also be used to perform the method 500.

The method 500 may include receiving 504 a user selection of the game entry point. This may include receiving a message at a host server 202 as a result of user selection of the game entry point on a workstation 212. The method 500 may further include receiving 506 a user selection of network profile identifiers and transmitting 508 invitations to join in a group game to the identified users.

Various methods may be used to receive 506 a selection of invitees and transmit 508 the invitations to the invitees using a social networking interface. An inviter player may, for example, select invitee players from a contact list or friends list including identifiers for the network profiles of other users and then issue invitations to an inbox or other messaging data structure of a social networking profile of an invitee player using communication methods known in the art of social networking. The invitation may include hypertext, buttons, or other user interface elements allowing the invitee player to click on the invitation when viewed in the network profile interface to indicate to the host server 202 an acceptance of the invitation. The invitation may be generated by the host server 202 and transmitted by means of the host server 202. For example, a locally executing application or interface to an application executing on the host server 202 may receive identifiers for prospective players and transmit invitations with required codes or user interface elements to the inbox of the invitee player's networking profile.

Alternatively, the invitation may include a game identifier. The invitee player may then transmit the game identifier to the host server 202 identifier upon initiation a game, such as by performing steps 502 and 504 using a network profile interface. The game identifier may be supplied by the user to the host server 202 upon initiating the game by performing steps 502 and 504. Alternatively, the game identifier may be transmitted from the host server 202 to the user's inbox upon performance of the steps 502 and 504. In some embodiments, invitations including a link, game identifier, or other access code, may be transmitted by email, text message, or the like, and accepted in the same manner as described above.

The host server 202 may receive 510 acceptances from one or more of the invitees. As noted above, acceptance may be initiated by an invitee may clicking a link in the invitation or by selecting a game entry point and entering a game identifier or other code in a game interface presented on the invitee computer. In embodiments where payment of a game fee is required the host server 202 may receive 512 payment of a game fee. As noted above, this may include receiving at the host server notification of payment of a game fee by a financial institution or other payment processing entity.

The method 500 therefore includes steps of presenting 514 products for game rewards on the user computers, and receiving 516 user selections of one or more desired products, which may include a ranking of the desired products. Interacting 518 with the players to provide the game play may be through a web browser executing on each of the inviter and invitee computers or an independent application. Interaction 518 between players may be managed on the host server 202 in data communication with the user computers or may be performed by the user computers with interaction achieved by communication between user computers.

The method 500 may include selecting 520, by the host server 202 or an application executing on the player computers, one or both of a prize product and a promotion, such as a discount amount, according to the outcome of the game. In some embodiments, selection 520 of a prize may be as described hereinabove except that the prize product selected 520 for an individual player may be any of the products selected by any of the other players of the group. Alternatively, the pool of products from which the prize product is selected 520 may include those of some or all of the players in the group as well as one or more other products that were not selected by any of the players. As already noted hereinabove, in embodiments where a game fee is required to play the value of the promotion, such as the value of a discount, is preferably at least as great as the game fee. The prize product and promotion may then be presented 522 to the players. Upon redemption of one or more of the promotions, the host server 202 may receive 524 or verify receipt of an affiliate fee from the merchant providing the prize product and promotion.

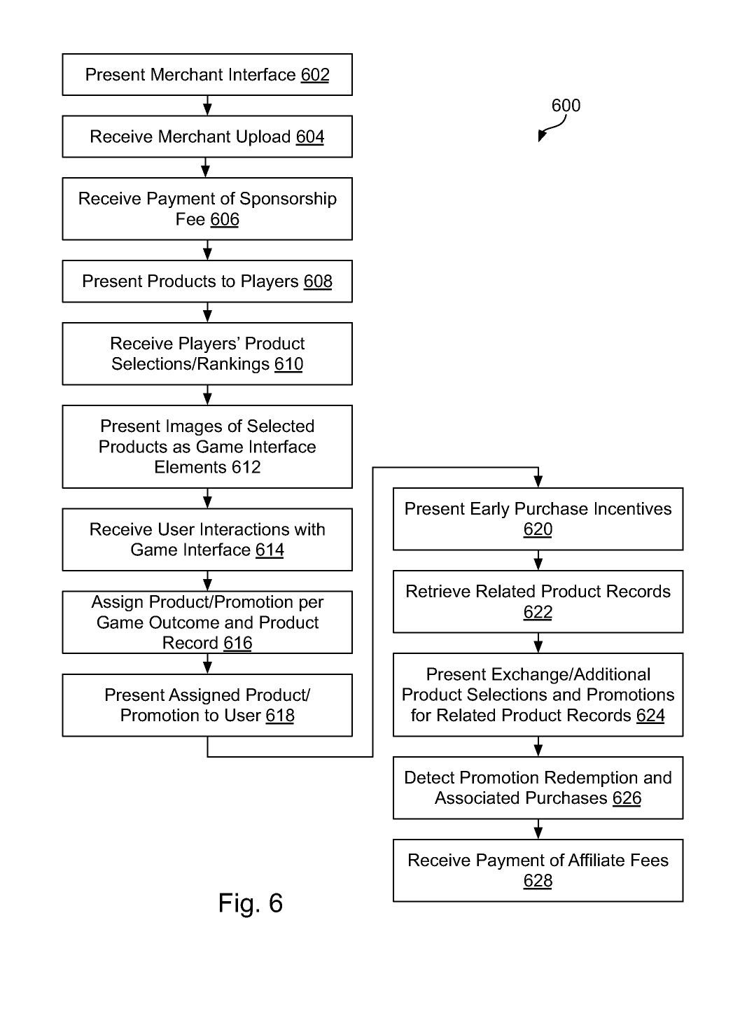

FIG. 6 illustrates a method 600 for obtaining products for use in a product-based game from a merchant. The method 600 may include presenting 602 an interface to a merchant. The interface may be graphical interface presented in a browser executing on a workstation 212 associated with a merchant. Alternatively, the interface presented may be a network interface available for communication with a merchant computer according to a protocol. The host server may receive 604 an upload from the merchant. The upload may include product records identifying one or more items of information such as a consumer identifiable product name, a product code such as a UPC, a permitted discount amount or range of permissible discount amounts, one or more promotion parameters (e.g., buy one get one, free gift, etc.), a price, an expiration date after which the product will no longer be available for use in a product-based game, and like information. The information receive 604 may also include information establishing a merchant account such as a merchant identifier and password, payment information for paying sponsorship or affiliate fees, and the like.

The method 600 may further include receiving 606 payment of a sponsorship fee. In some embodiments, receiving 606 payment of the sponsorship fee may include receiving verification of payment of the fee from another entity, such as a financial institution. The sponsorship fee may be a fee paid in order for the host server 202 to provide the merchant's product's as part of the product-based game and may also include a fee for providing advertising, e.g., banner ads, as part of a game interface. Where a merchant has a paid up sponsorship fee or a fee is otherwise not required, the step of receiving 606 payment of the sponsorship fee may be omitted.

The products received 604 from a merchant may then be presented 608 to players for selection as part of a product-based game. The products presented 608 may include those received 604 from multiple merchants. As noted above, presenting 608 products to players may include providing a web-based interface that is navigable and searchable. As in the other methods described herein, the method 600 may include receiving 610 a player's selection of one or more products from the interface for each player. Receiving 610 a player's selection may include receiving multiple products along with a ranking of the selected products.

The method 600 may include providing game play to one or more players. This may include presenting 612 one or more of a player's selected products as interface elements in a game interface and interacting 614 with one or more players to provide game play. In some embodiments, steps 612 and 614 may be performed by a software module executing on a user workstation 212.

Upon conclusion of the game, a player may be assigned 616 one or both of a product and a product promotion, such as a discount amount, based on the outcome of the game. The product assigned and the promotion may be defined by product records received 604. The product and/or promotion assigned 616 may then be presented 618 to the player. Presenting 618 the promotion may include transmitting a promotion message identifying the product and/or promotion to a workstation 212 associated with a user.

The method 600 may include presenting other information to the user along with the promotion message. This may include presenting 620 early purchase incentives. The purchase incentives may include free products for purchase by a deadline, additional promotions for the prize product, and the like. The method may also include retrieving related product records 622 and presenting 624 the retrieved products along with discounts or offers to purchase the retrieved products. As in other steps of the method 600, presenting may include transmitting the information to a user workstation 212.

The method 600 may further include detecting 626 redemption of any promotions or product offers presented in steps 618, 620, or 624. Detecting 626 may include receiving notice from a merchant that uploaded a record for the product redeemed that a product associated with one of the products offered in steps 618, 620, or 624. The method may also include receiving payment 628 of an affiliate fee, which may include receiving notice of payment of the affiliate fee from a financial institution.

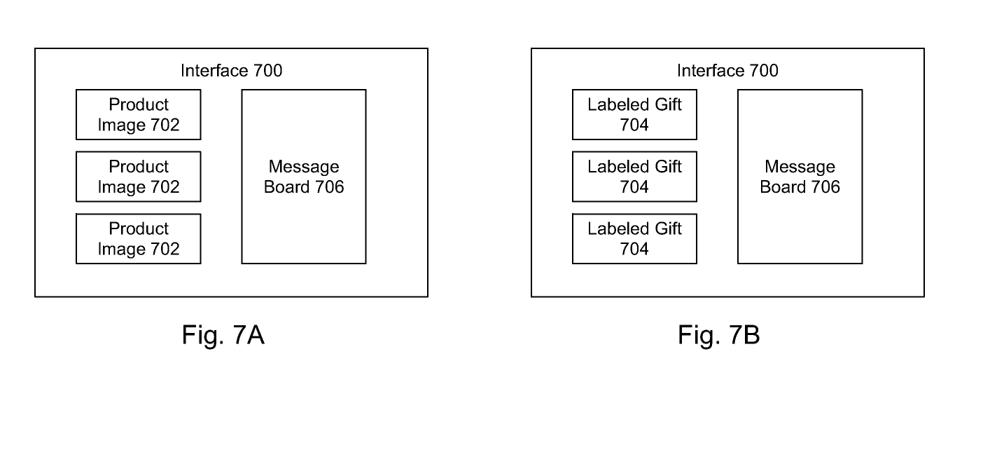

FIGS. 7A through 15 illustrate an interface and flow diagrams for an example of a product-based game. The illustrated game may is a “white elephant” type game. Referring specifically to FIG. 7A, one or more players select products and graphical representations of these products are presented as user interface elements 702. The user interface elements 702 may include other products not selected by any of the users. Referring to FIG. 7B, during game play, the interface elements 702 may be replaced with wrapped representations 704 that obscure the identity of the products. The wrapped representations 704 may be labeled with the name of the player to which they correspond. One of the wrapped representations 704 may correspond to a white elephant gift that was not picked by any of the players but which is nonetheless labeled with the name of one of the players to obscure its identity. The interface 700 may further include a message board 706 for posting messages during game play as described hereinabove.

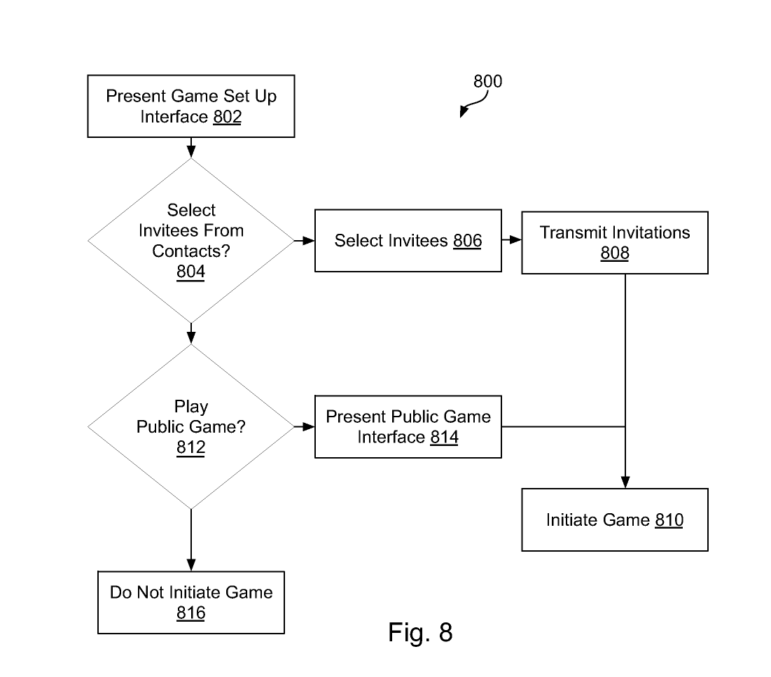

FIG. 8 illustrates a method 800 for initiating a game, such as a product-based game or a product-based white elephant type game. The method 800 may be used with a social networking system and may be integrated with a social networking profile interface. The method may include presenting 802 a game setup interface. Presenting 802 may include defining an interface for presentation on a social networking profile interface viewed by an inviter player. The method 800 may include determining 804 whether a player intends to add invitee players from contacts associated with the player's social networking profile. This may include receiving a user input such as a mouse click on a button or other interface element. If the player intends to invite contacts to play, then the player selects 806 invitees from those associated with the profile and these invitees are received by the host server 202. The invitations are than transmitted 810 to the invitees and the game is initiated 810. The method 800 may include evaluating 812 whether the user intends to play a public game. This may include evaluating 812 whether a user has clicked or otherwise interacted with a user interface element indicating intent to play a public game. If so, then the user may be presented 814 with a public game interface and the game may be initiated 810. The public game interface may be presented along with the social networking profile interface. A public game may be initiated when a minimum number of players have chosen to play a public game. If the user does not intend to select invitee players from contacts or play a public game, then the method 800 may refrain 816 from initiating a game.

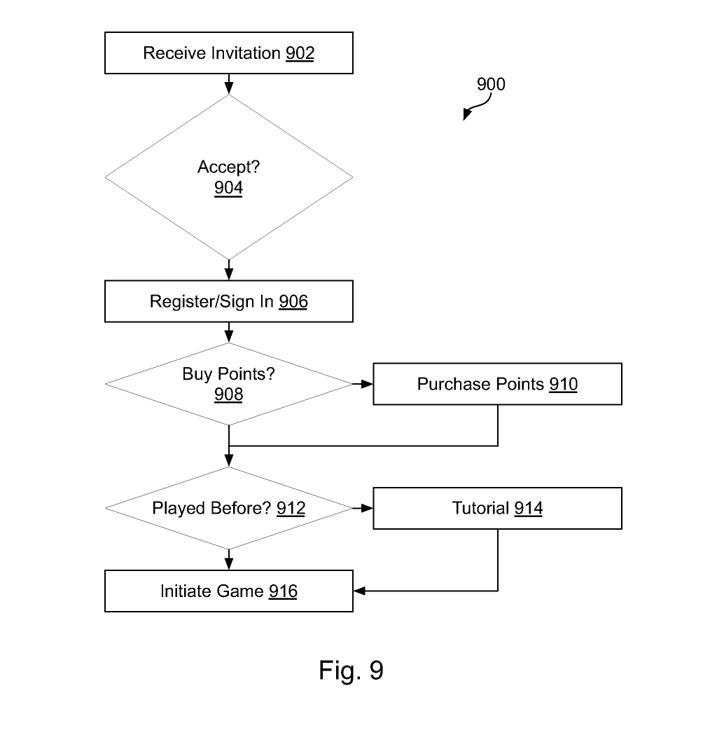

FIG. 9 illustrates a method 900 for adding an invitee and inviter to a game. The method 900 may be executed following execution of the method 800 as part of initiating 810 a game. The method 900 may include receiving 902 an invitation, for the case of an invitee. The invitation may be received by associating the invitation with the invitee's social networking profile such that the invitation is visible when the invitee is viewing the social network profile interface. The invitee's acceptance of the invitation may be evaluated 904. This may include whether the user has clicked or otherwise interacted with a link, button, or other user interface element. If the invitee accepts the invitation, the user may register and/or sign in 906 to the game. This may be performed automatically upon acceptance automatically or may require the invitee to enter a user name and password or generate a new user account with a user name and password. An inviter may also sign in or register.

The method 900 may include evaluating 910 whether a user wishes to buy points. If so, then the host server 202 manages interactions required for the user to transfer money to the entity owning or controlling the host server and associates points with the purchaser of the points. The method 900 may also include evaluating 912 whether a prospective player has played before. If not, then the host server 202 may present 914 a tutorial to the player. In either case, a game is then further initiated 916.

The following figures and description describe the logic of providing a white elephant type game. The method steps described may be executed on the host server 202, on a player workstation 212, a combination of the two, or by some other device alone or in combination with these devices. Interaction and instructions from players may be received and processed on a player workstation 212 or received on the player workstation 212 and transmitted to the host server 202 for processing.

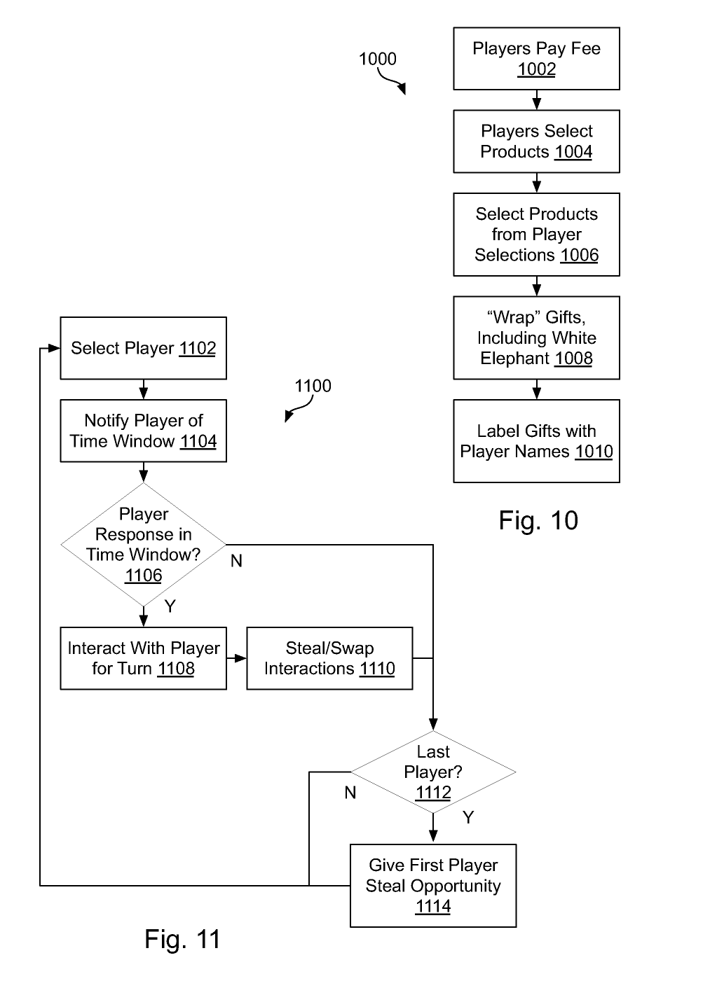

A game may begin with execution of a method 1000 of FIG. 10. The method 1000 may be executed after the methods 800 and 900. The method 1000 may include receiving 1002 player fees and receiving 1004 the player selections of products for each of the players as described hereinabove. The method 1000 may then include selecting 1006 products from among the products selected by each player. In some embodiments, one product may be selected 1006 from each player's selections. Each of the gifts selected at step 1006 may be wrapped 1008, this may include presenting interface elements representing the products with symbols that do not reveal the identity of the products. One of the wrapped gifts may include a white elephant gift. The white elephant gift may include an undesirable product, no product at all, or a randomly selected product. In some embodiments, the wrapped gifts may be labeled 1010 with player's names. The player's name labeling a gift may correspond to the player that selected the gift, except for the white elephant gift. Labeling may include displaying the player's name on or by an interface element representing a gift.

FIG. 11 illustrates a method 1100 outlining game play for a white elephant type game. A player is selected 1102 from among the players associated with the game and the selected player is notified of a time window for completing and/or commencing the player's turn. If the player is found 1106 to have responded within the time window, the method 1100 includes interacting 1108 with the player and managing 1120 stealing and swapping interactions between players during the player's turn, such as is described in greater detail below. If the selected player is found 1112 not to be the last player than another player is selected 1102. If the selected player is found 1112 to be the last player, than the player first selected to take a turn is given 1114 an opportunity to steal a gift from any other player. Some exceptions to this may be permitted, for example, if another player has paid a lock fee or has immunity from stealing, stealing by the first selected player may not be permitted in some embodiments.

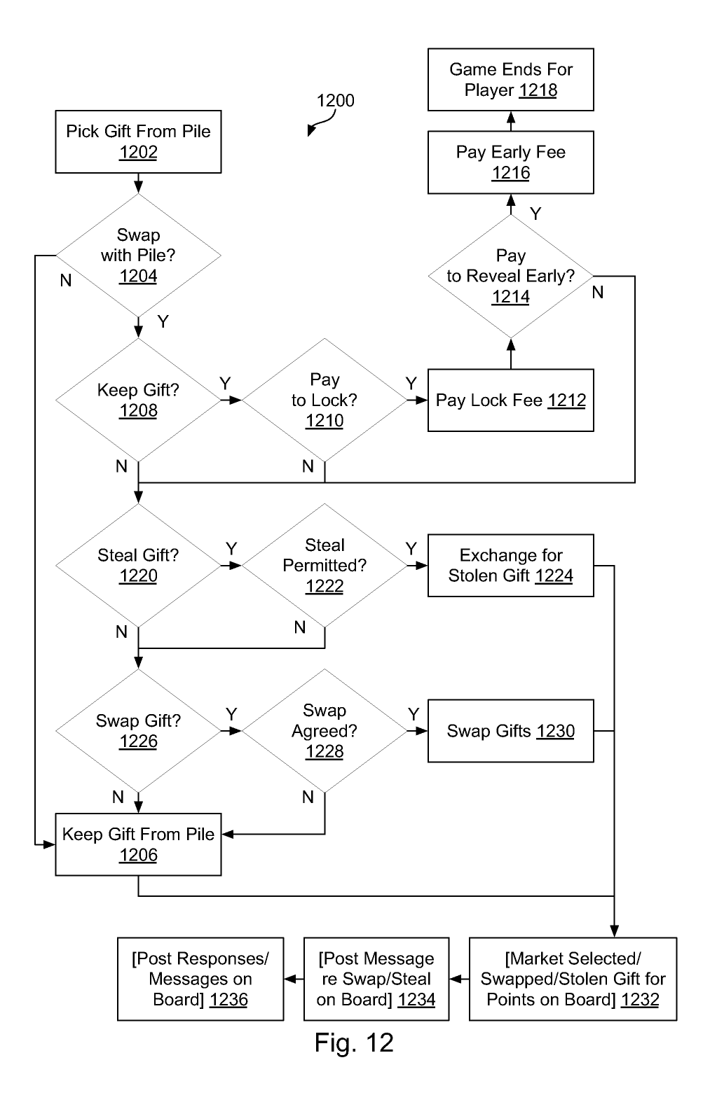

FIG. 12 illustrates a method 1200 for conducting a player's turn in a white elephant type game. A player's turn may include picking 1202 a gift from a pile of gifts. The contents of the gifts may be obscured and may include gifts selected by each player as described in the methods hereinabove. The gifts may also include a white elephant gift which may correspond to no product at all, an undesirable product, or a randomly chosen product. Upon picking the gift, the product corresponding to the picked gift may be revealed to the player and possibly to the other players.

The player may then choose 1204 whether to swap the gift with another gift from the pile. If not, the player will keep 1206 the gift from the pile. If so, then the player swaps gifts with the pile and has an option to keep the gift swapped from the pile may choose 1208 whether to keep the second gift from the pile, after finding out the product associated with the second gift. If the player chooses to keep the gift, then the user may choose 1210 to pay a lock fee to prevent loss of the gift during later game play. If the player chooses to pay a lock fee then the lock fee is paid 1212 and received by the entity associated with the host server. The player may also choose 1214 whether to pay an early fee. If the player chooses 1214 to pay the fee, then the fee is paid 1216 and the game ends 1218 for that player.

If a player chooses 1208 not to keep a gift selected from the pile on that turn, the player may choose 1220 to steal a gift from another player. If so, then the method 1200 may include evaluating 1222 whether steal is permitted according to game logic described herein below. If so, then the gift associated with the player is exchanged 1224 with a gift associated with another player chosen by the player. A player may choose 1226 to swap gifts with another player rather than to steal a gift. If the other player is found 1228 to agree with the swap, then the player and the other player exchange 1230 gifts. This may include changing the gifts associated with each player's game state.

In some embodiments, a message board as known in the art may be accessible and viewable by the players and may provide the ability for player's to post comments. In such embodiments, a player's turn may include marketing 1232 the product associated with a user on the message board to earn points, posting messages 1234 regarding transactions (swaps or steals) that took place during the player's turn, and post 1236 responses to other messages. Messages 1234 regarding transactions (swaps or steals) may include automatically generate text that the player may edit or not and then post to the message board or transmit to the other part of the transaction. Marketing messages may result in points being associated with the user for use at different points in the game.

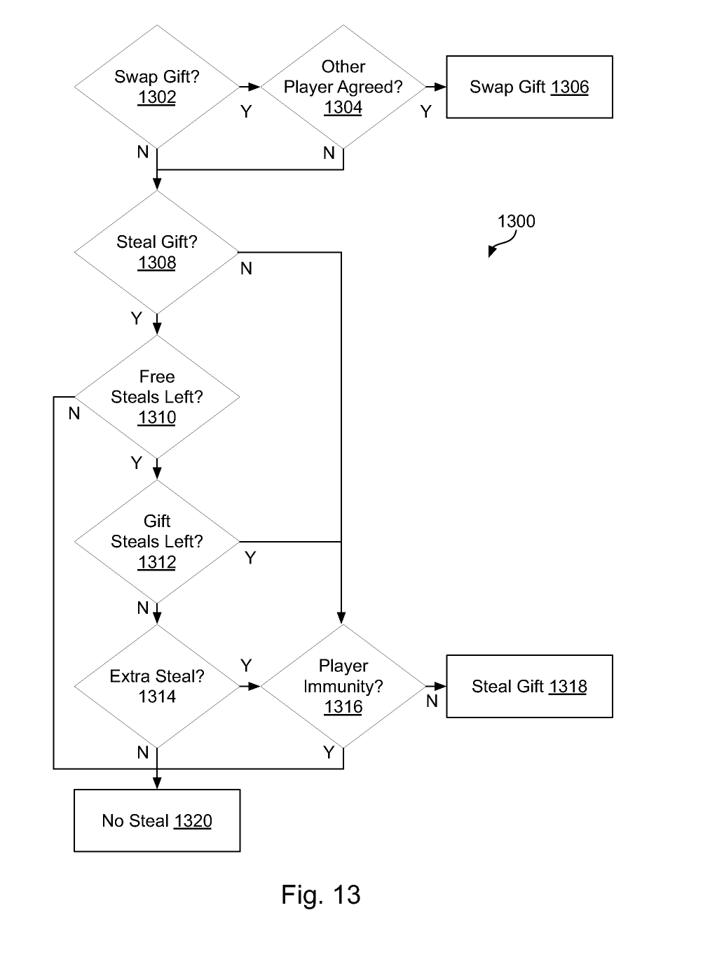

FIG. 13 illustrates a method 1300 for controlling the exchange of gifts between players. The method 1300 may include evaluating whether a player chooses 1302 to swap gifts with a second player and evaluating 1304 whether the second player agrees to the swap. If the player chooses to swap and the second player agrees, then the exchange of gifts is performed by swapping the identifiers of the products associated with the swapping players.

The player may also indicate a choice 1308 to steal a product from a second player. If so, then the method 1300 may include evaluating 1310 whether the player has any steals left. Upon the commencement of the game a player may be given a certain number of steals that are used up with each steal. In some embodiments, additional steals may be purchased using points acquired by purchase or during game play. In some embodiments, a steal may be purchased outright. If the player is found 1310 to have free steals, the method 1300 may include evaluating 1312 whether the gift the player wishes to steal has remaining steals. Each gift may have a number of permitted steals associated therewith such that it can only be stolen a certain number of times before it can no longer be stolen. If the gift is found 1312 to not have any more steals, the method 1300 may include evaluating whether the stealing player has an extra steal. An extra steal may be purchased with points or money and allows a player to steal a gift notwithstanding the fact that the gift has no more steals left.

If the player chooses to steal the gift, has free steals left, and the player has an extra steal or the gift has steals left, the method 1300 may include evaluating 1316 whether the second player has and chooses to use immunity from stealing. An immunity may be purchased with points or money and is used up by choosing to invoke the immunity in response to an attempt to steal. In some embodiments, once the immunity is used it cannot be used again and another immunity must be purchased if one is to be used.

If the player cannot or chooses not to use immunity, then the gift of the second player is stolen 1318. This may include swapping the product identifiers of the products associated with the stealing player and the second player. If the player uses immunity or the steal is otherwise not permitted according to other method steps, then the steal is refused 1320.

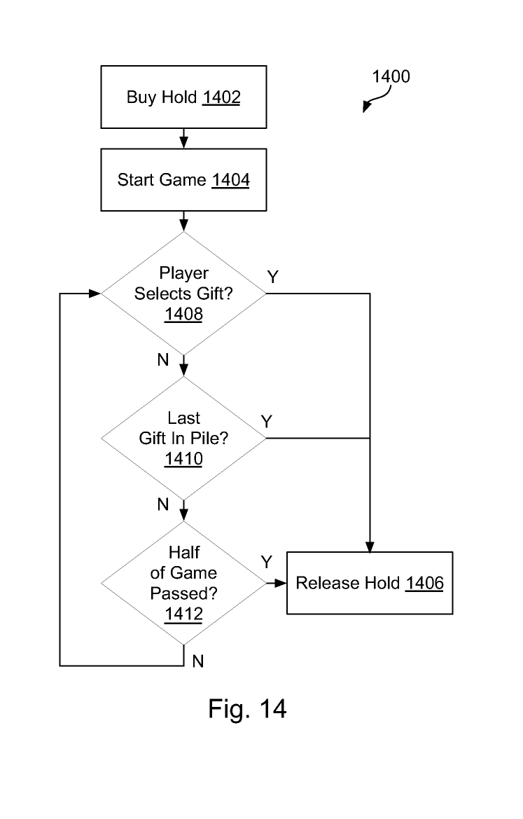

FIG. 14 illustrates a method 1400 for providing a hold to a player. A player may not be able to participate at the commencement of a game or may otherwise wish to prevent others from selecting a product selected by that player. Accordingly in some embodiments a user may purchase 1402 a hold prior to the start of a game. The hold may be purchased with points or money. The game may then commence 1404 as described hereinabove, for example player turns may commence according to the method 1100. The product associated with the player will then be unavailable for choosing from the gift pile by any of the other users until the hold is released. The hold is released 1406 if the held product is found 1408 to have been selected from the gift pile by the player who purchased the hold, the held product is found 1410 to be the last gift in the pile, or half the game is found 1412 to have passed. Half the game may be found 1412 if half the players have already taken their turn or half of a defined play time period has elapsed.

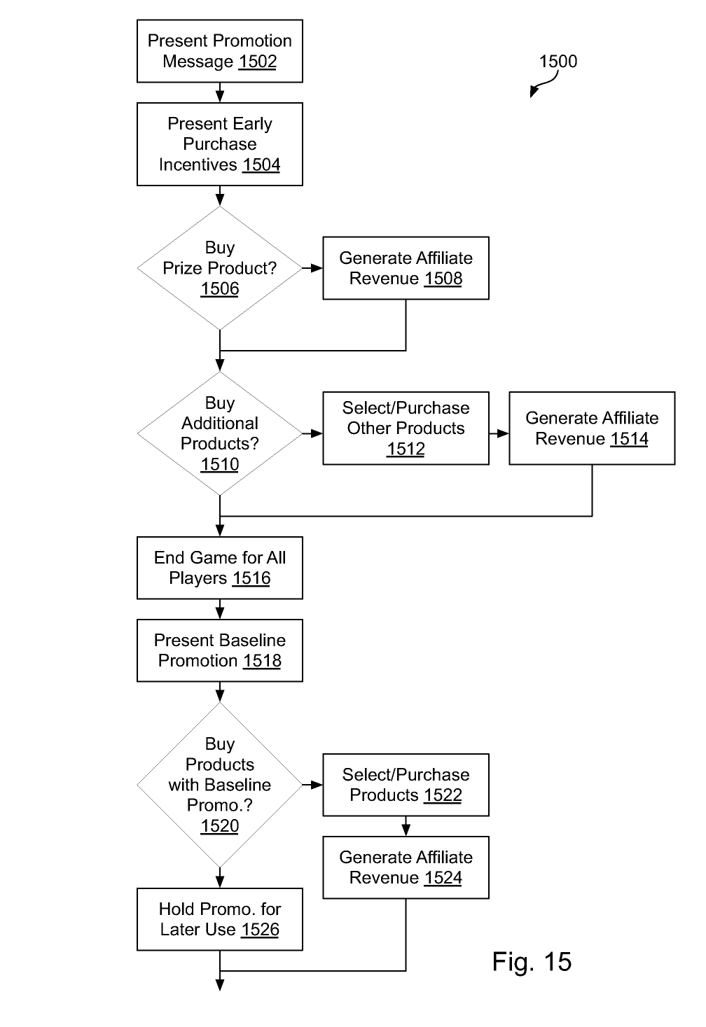

FIG. 15 illustrates a method 1500 for presenting a prize product and a promotion, such as discount amount, according to an outcome of a product-based game, such as the white elephant type game described hereinabove. The method 1500 may include presenting 1502 a promotion message including a promotion description, such as a discount amount, and a prize product determined according to an outcome of the game as described herein below. The method 1500 may also include presenting 1504 early purchase incentives. The early purchase incentives may include an additional discount, an additional free product given if the promotion is redeemed or other incentive given to a player if the promotion is redeemed by a certain time. The player may then choose 1506 to buy the prize product. If so, then affiliate revenue may be generated 1508 for an entity owning or controlling the host server 202. The affiliate revenue may be a commission for the purchase of the prize product. The user may also be presented with a choice 1510 to buy additional products. If so, then the selection and purchase of the products may be completed 1512 and additional affiliate revenue may be generated 1514 for the entity owning or controlling the host server 202.

As noted above, in some embodiments, a player may choose to end the game early, which may include payment of an early fee. In such embodiments, the game may end 1516 after a user has an opportunity to see the promotion message and redeem the promotion. However, even where an early end has been chosen, the end of the game for other players may precede or follow redemption of a discount by a player. Upon ending 1516 of the game for all players, all players may be presented 1518 with a baseline discount or baseline promotion, such as a baseline discount, that is independent of the outcome of the game and offers all players an opportunity to purchase products with the baseline promotion. As in other embodiments, the baseline promotion may be in the form of a promotional code or other data structure enabling a user to purchase a product at a discount. The player may then choose 1520 whether to buy products using the baseline promotion. If so, then the player may complete 1522 selection and purchase of the products benefiting from the baseline promotion, which may include generating 1524 affiliate revenue for an entity owning or controlling the host server 202. If a player chooses 1520 not to purchase products using the baseline promotion, then the player may hold 1526 the baseline promotion for later use.

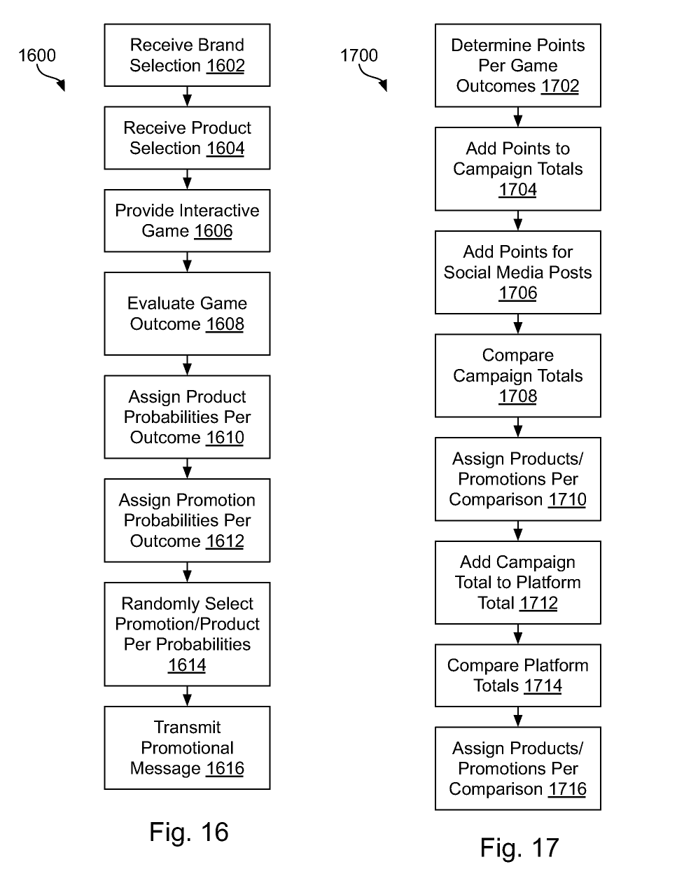

FIG. 16 illustrates an alternative method for conducting a product-based game. The method 1600 may include receiving 1602 a brand selection. Brand selection may include the selection of manufacturer brand or a retailer brand. The player's product selection may also be received 1604. Receiving a player's product selection may also include receiving a player's ranking of the selected products. Where a brand selection has been received 1602, then the product selection may be limited to those associated with the selected brand, e.g., made by the brand manufacturer, products offered by the brand retailer, or products part of a sponsored advertising campaign. In some embodiment, receiving 1602 the brand selection may automatically result in selection of a set of products such that receiving 1604 a player selection is omitted. Receiving 1602 a brand selection and/or receiving 1604 a product selection may be performed on the user workstation 212 or on the host server 202.

The method 1600 may then include providing 1606 an interactive game to a user. The game interface for providing 1606 the interactive game may be displayed on the player workstation 212. Functions for updating the game interface and updating the game state in response to user inputs may be executed on one or both of the user workstation 212 and host server 202.

The outcome of the game may then be evaluated 1608. Evaluating 1608 may include evaluating a point total, success of failure at completing a task, or some other metric. A probability of obtaining a particular product may be assigned 1610 according to the evaluation 1608 of the outcome. In some embodiments, probabilities may be assigned 1610 to each, or each of a subset, of the products identified in the product selection received 1604. An additional probability may be generated according to the outcome indicating the likelihood of the user not receiving a promotion for any product. The method 1600 may also include assigning 1612 one or more probabilities to one or more promotion types or amounts. For example, probabilities of obtaining X, Y, and Z % discounts may be determined, where X, Y, and Z are values between 100 and 0. In some embodiments, promotion types may include promotions other than discount percentages such as “buy one get one free” offers, a free gift with purchase, access to exclusive online content, or other promotions described herein or as known in the art. In some embodiments, larger discount amounts or more valuable promotions may be assigned a larger probability for a larger point total or a successful completion of a task. In some embodiments, the sum of the probabilities for each possible promotion is equal to 1, or, stated differently, the probability of obtaining at least one promotion is 100%. A product and promotion may be randomly or pseudo-randomly selected 1614 according to the probabilities assigned at steps 1610, 1612. The steps of assigning 1610, 1612 probabilities and selecting 1614 a product and promotion may be performed on one or both of a player workstation 212 or on the host server 202. A promotional message indicating the selected product and promotion may then be transmitted 1616 to the player workstation 212 and/or displayed on the player workstation 212. The method of FIG. 16 may be combined with any of the foregoing methods. In particular, any of the games or methods for initiating games described herein may be used with the method 1600.

In some embodiments, a player may be limited to one promotion per product within a given time period, e.g., per day, week, month, season, and the like. In such embodiments, if a product is randomly selected for which a promotion has already been awarded to a player within the given time period, another product may be selected or only a specified number of points may be assigned to a player's point total for future use, such as for promotions assigned using the method of FIG. 17 described herein below. In some embodiments, the method includes alerting a player that the player is not eligible to obtain another discount for a product if the player attempts to play for a discount to product. In some embodiments, a player is not eligible to win a promotion for a product is an unexpired and unredeemed promotion for the same product has already been assigned to the player, but may be eligible following expiration or redemption of the promotion.

Tables 1 and 2 illustrate examples of how probabilities of obtaining a product may be assigned 1610 and probabilities of obtaining a promotion may be assigned 1612. The steps of assigning 1610, 1612 probabilities may be performed by looking up probabilities from tables, such as Tables 1 and 2.

TABLE 1
Product Probabilities

| | Only | ⅙ of | | | | | | | |
|---|---|---|---|---|---|---|---|---|---|
| Points | Points % | Items % | Item 1% | Item 2% | Item 3% | Item 4% | Item 5% | Item 6% | Total % |
| 1,000- | 25 | 75 | 10.67 | 10.00 | 9.41 | 8.89 | 6.67 | 5.33 | 100 |
| 9,999 | | | | | | | | | |
| 10,000- | 20 | 80 | 8.00 | 8.22 | 8.22 | 8.45 | 6.98 | 5.88 | 100 |
| 39,999 | | | | | | | | | |
| 40,000- | 15 | 85 | 6.27 | 6.89 | 7.24 | 8.07 | 7.43 | 6.72 | 100 |
| 59,999 | | | | | | | | | |
| 60,000- | 10 | 90 | 5.08 | 5.86 | 6.43 | 7.73 | 8.08 | 8.08 | 100 |
| 79,999 | | | | | | | | | |
| 80,000- | 5 | 95 | 4.21 | 5.05 | 5.74 | 7.43 | 9.02 | 10.53 | 100 |
| 150,000 | | | | | | | | | |

TABLE 2
Promotion Probabilities

| | 15% | 20% | 25% | 30% | 35% | 40% | |
|---|---|---|---|---|---|---|---|
| Points | off % | off % | off % | off % | off % | off % | Total % |
| 1,000- | 27 | 25 | 18 | 15 | 10 | 5 | 100 |
| 9,999 | | | | | | | |
| 10,000- | 21.5 | 21.25 | 17.25 | 15.75 | 13.75 | 10.5 | 100 |
| 39,999 | | | | | | | |
| 40,000- | 16 | 17.5 | 16.5 | 16.5 | 17.5 | 16 | 100 |
| 59,999 | | | | | | | |
| 60,000- | 10.5 | 13.75 | 15.75 | 17.25 | 21.25 | 21.25 | 100 |
| 79,999 | | | | | | | |
| 80,000- | 5 | 10 | 15 | 18 | 25 | 27 | 100 |
| 150,000 | | | | | | | |

FIG. 17 illustrates a method for assigning products and promotions according to a game outcome for a player. The playing of games and accumulation of points during a game may be as described in any of the methods described herein. The method 1700 may include determining 1702 a number of points according to a game, with the game being played and points accumulated according to any of the methods described herein. In certain embodiments, games are provided in the context of an advertising campaign. The campaign may be in the context of a specific manufacturer or retailer brand. Accordingly, a brand selection (such as described as part of the method 1600) may invoke a game associated with an advertising campaign for that selected brand. In such embodiments, a player's point total from a game played in the context of an advertising campaign may be added 1704 to a campaign total for the player.

Points may also be added 1706 to the campaign total for postings messages regarding one or more of the game, branded products, and the brand associated with the advertising campaign. The postings may be made to a player's social media account through an interface provided by the host server 202 or on the player workstation 212 such that a provider of the advertising campaign can verify the content and actual posting of the player's comments. Alternatively, the fact of a player's social media postings may be verified after the fact by accessing the player's social media site and analyzing the content thereof.

Additional points may be awarded for a “paired game.” A paired game is a game in which two players agree to play the same game. Upon both players completing the game, both players are awarded additional points. Paired games encourage people to recruit other players. Paired games may be set up using social media sites as discussed herein. Actual interaction between the players during a paired game is not required. In some embodiments, additional point for paired games will not be awarded more than once to the same pair of players within a given period, such as 24 hours. However, an individual player may have paired games with multiple other players and still receive the additional points for paired games.

In some embodiments, a player may be limited on the number of games that may be played per day for points to be added to the campaign total. In still other embodiments, the number of individual games is limited, but the number of paired games is not, or has a separate limit, provided a player is paired with a different player for each paired game.

The campaign totals for a plurality of players may be compared 1708 to one another and products and corresponding promotions may be assigned 1710 to one or more of the players according to the comparison. In some embodiments, the promotions assigned based on campaign totals are for items of greater value and greater appeal and the discounts offered may be even larger (such as up to 99% off). Assigning 1710 a product and promotion may include assigning a probability of obtaining a promotion for a coveted product according to a rank of a player's campaign point total and then randomly or pseudo randomly assigning a product and/or promotion according to that probability. In alternative embodiments, the probability of a promotion for a product and the probability of obtaining a particular promotion are assigned to each player independently according to campaign point totals as described with respect to the method 1600 of FIG. 16. Assigning 1710 of products and/or promotions may occur periodically during an advertising campaign, at the end of an advertising campaign, or at some other interval in a fixed or open time period. In some embodiments, a promotion for a product may be assigned or not assigned upon a player achieving one or more campaign total thresholds according to some predetermined probability.

In some embodiments, a player's campaign totals and/or individual game totals may be added 1712 to a platform total for that player. The platform total may reflect all points accumulated from playing games provided by a certain provider. The platform total may indicate total points with respect to individual games and/or a lumped sum of all points. The player's platform total 1712 may be compared 1714 to platform totals for other players, either with respect to individual games or a lump sum of points accumulated for all games. A product and promotion may then be assigned 1716 according to the comparison. Assigning 1716 a product and promotion may include assigning a probability of obtaining a promotion for a coveted product according to a rank of a player's platform total and then randomly assigning or not assigning the promotion for the product according to the probability. Alternatively, the type of promotion and the product associated with a promotion may be independently assigned based on a player's platform total, such as using the method 1600 of FIG. 16. Assigning 1716 of products and/or promotions may occur periodically during the operation of a game platform. In some embodiments, a promotion for a product may be assigned 1716 or not assigned upon a player achieving one or more platform total thresholds according to some predetermined probability.

Any number of games may advantageously be provided using the methods and systems described herein. Various examples of such games are described herein. As noted previously, the games may advantageously use images for products that can be awarded as part of a promotion as interactive game interface elements.

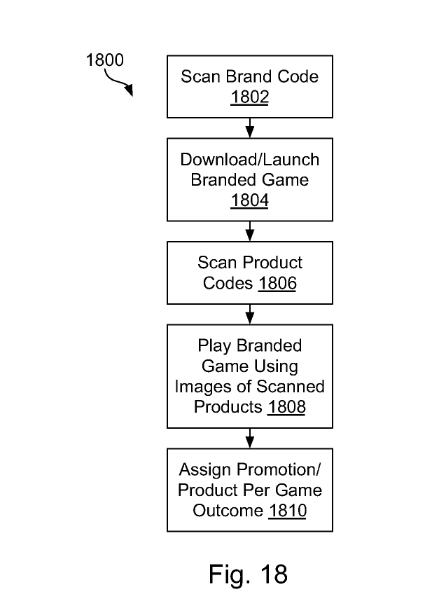

FIG. 18 illustrates a method for initiating and playing a product-based game using a smart phone or other device capable of scanning optical codes such as universal product codes (UPC), quick response (QR) codes, text labels, and the like. The steps of the method 1800 may be executed on a player workstation 212 or on a host server 202. The method 1800 includes scanning 1802 a brand code with the player workstation 212, such as using the camera of a workstation 212 embodied as a smart phone or other portable computing device. Other scanning devices, such as laser scanners may also be used. The brand code may be an optical code. The brand code may be unique to a retailer, manufacturer brand, or a specific ad campaign. Scanning of the brand code may trigger downloading and/or launching of a branded game 1804 corresponding to the retailer, brand, ad campaign, or the like associated with the brand code. In instances where the correct game is already downloaded this step may be omitted. In some embodiments, where the game is already downloaded on the player workstation 212, step 1804 may include downloading information sufficient to execute the game with content corresponding to the brand code.

A player may then scan 1806 product codes, such as by scanning optical codes affixed to products at a retail location or scanning some other type of display including optical product codes. Scanning 1806 may be done with a camera coupled to the workstation 212, or by means of some other scanner coupled to the workstation 212. The products that may be scanned and used for assigning promotions may be limited to a subset of all products available at a retail location in accordance with an ad campaign associated with the brand code. Scanning 1806 may be executed within the context of execution of the game launched or downloaded at step 1804.

A branded game may then be provided 1808 using images of the products scanned 1806 as one or both of interactive elements of the game interface and as a reward in the form of a promotion according to an outcome of the game. A promotion may then be assigned 1810 according to the game outcome according to any of the methods described herein. The promotion may be displayed on the user workstation 212 upon assignment and may include an optical code that may be scanned by a scanner, such as a laser scanner, at a point of sale (POS) device in order to redeem the promotion when purchasing the product associated with the promotion.

In some embodiments, a significant time delay, e.g. hours or days, may pass between the scanning 1806 of product codes 1806 and playing 1808 of a branded game. For example, by scanning a code a player may notify a host server of a desire to play a game corresponding to the scanned code. When a branded game corresponding to the scanned code (e.g. the product or brand corresponding to the scanned code) a notice may be transmitted by the host server to the user, such as to the computing device used to scan 1806 the product code or some other device. The method 1800 may then continue with steps 1808 and 1810.

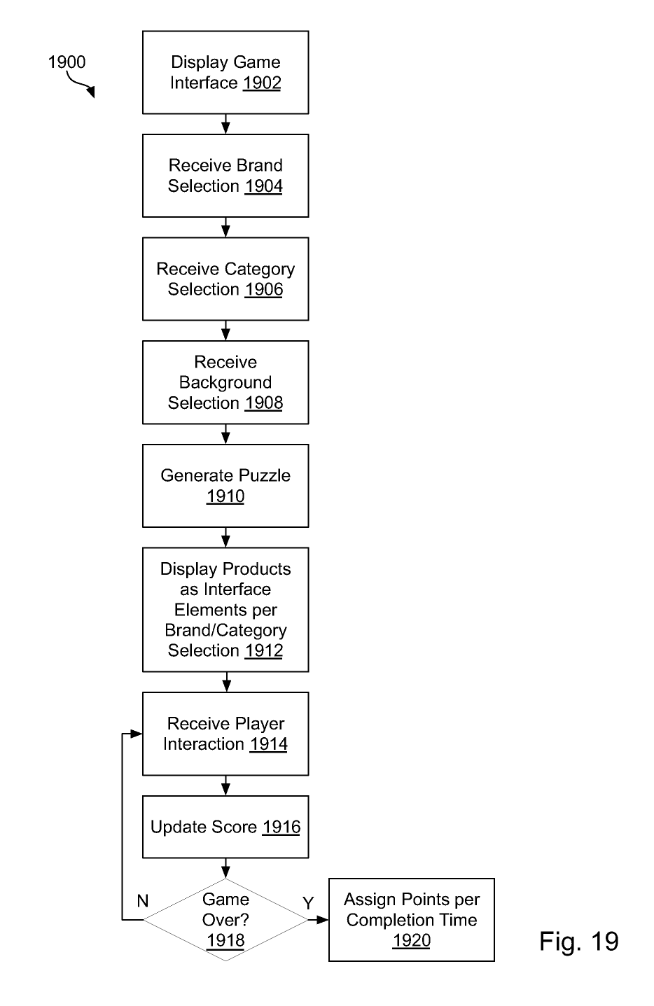

FIG. 19 illustrates a method 1900 for providing a branded product-based game. The steps of the method 1900 may be executed on a player workstation 212 or on a host server 202. The method 1900 may include presenting 1902 a game interface and receiving 1904 a brand selection from the player using the interface. The brand selection may identify a retailer, manufacturer, a particular product line, or group of products associated with a particular advertising campaign, or some other collection of products. The method may also include receiving 1906 a category selection that further limits the number of products that will be used. The category may be a sub-brand, product line, class of products (e.g., toys, kitchen tools, power tools, etc.), or any other subdivision of products. A player may also be permitted to select a background image. Accordingly, a background selection may also be received 1908. The options for the background selection may be determined by one or both of the brand selection 1904 and category selection 1908.

A puzzle may then be generated 1910 and displayed. The puzzle may be a conventional puzzle, such as a maze, or may be an interface to any type of game. Generating the puzzle may include displaying 1912 product images as interface elements in accordance with the brand and/or category selected at steps 1904, 1906 and displaying the selected background image. Player interaction with the interface may be received 1914 and a score updated 1916 according to the player interaction until it is found 1918 that the game is ended, either due to completion of a task, failure to complete a task, expiration of a time limit, or a player decision not to continue. Upon ending the game, points may be assigned 1920 according to a completion time or other metric of the player's performance. A promotion for a product associated with the selected brand and/or category may be assigned according to the methods described herein.

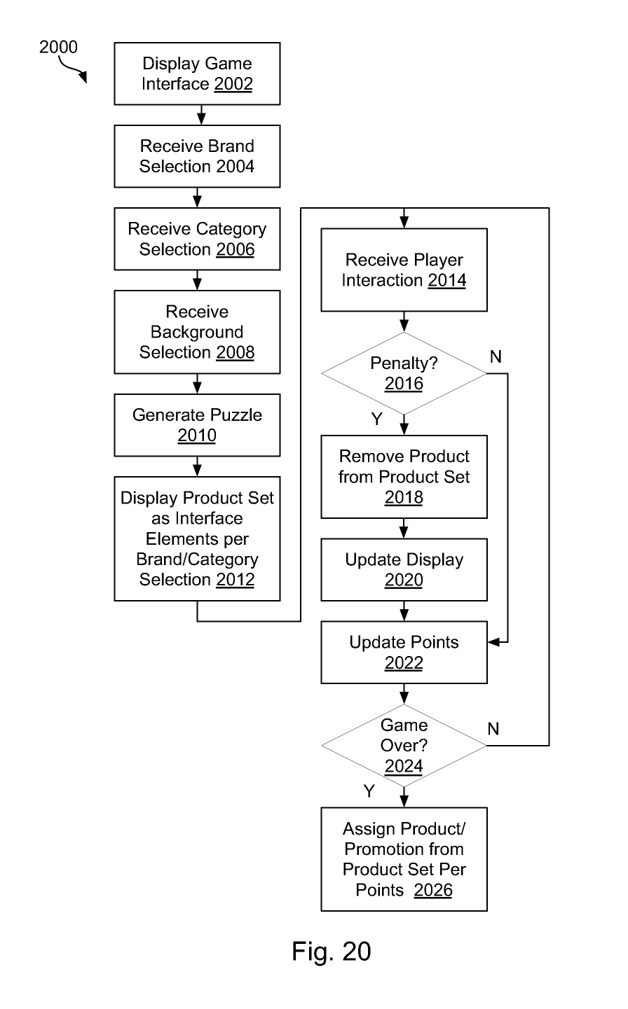

FIG. 20 illustrates another method 2000 for providing a branded product-based game. The steps of the method 2000 may be executed on one or both of a player workstation 212 and the host server 202. The method 2000 may include presenting 2002 a game interface and receiving 2004 a brand selection from the player using the interface. The brand selection may identify a retailer, manufacturer, a particular product line, or group of products associated with a particular advertising campaign, or some other collection of products. The method may also include receiving 2006 a category selection that further limits the number of products that will be used. The category may be a sub-brand, product line, class of products (e.g., toys, kitchen tools, power tools, etc.), or any other subdivision of products. A player may also be permitted to select a background image. Accordingly, a background selection may also be received 2008. The options for the background selection may be determined by one or both of the brand selection 2004 and category selection 2008.

A puzzle may then be generated 2010 and displayed. The puzzle may be a conventional puzzle, such as a maze, or may be an interface to any type of game. Generating the puzzle may include displaying 2012 images of products from a product set as interface elements in accordance with the brand and/or category selected at steps 2004, 2006 and displaying the selected background image. The product set may be determined according to the selection steps 2004, 2008 or may be individually specified by the player. Player interaction with the interface may be received 2014. The method 2000 may include evaluating 2016 the player interactions to determine whether to assess a penalty. For example, where the puzzle is a maze, products may be removed for wrong turns. If so, then a product is removed 2018 from the product set determined according to the selection steps 2004, 2006. The products may be removed randomly or more desirable products may be removed first. In some embodiments, a step is added whereby a player may rank potential products. In such embodiments products may be removed 2018 from a set of available products according to their ranks. The display may be updated to remove the image of the product removed from the product set. Following a player interaction, points may be assigned 2022 to a player's score (or subtracted) according to the game logic. If a game is found 2024 to have concluded, a product may be selected from those remaining in the product set and a promotion for the selected product may also be chosen. A game may end when there are no products left in the set, in which case the likelihood that no product will be awarded may be higher than if a product remained. A game may also end upon completing a task, failing to complete a task, expiration of a timer period, or a player input indicating intent to stop playing. Both the product and promotion may be selected according to methods described herein. If the game is not found 2024 to have ended another player interaction is received 2014 and the game continues.

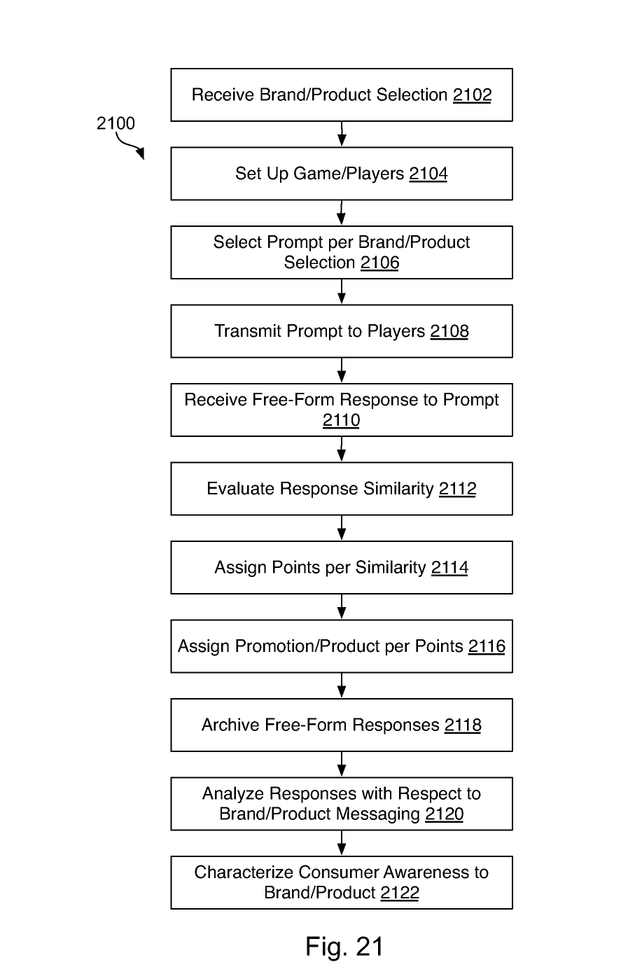

FIG. 21 illustrates a method 2100 for providing a product-based game that enables gathering of customer perceptions with respect to one or both of a brand or product. The method 2100 may be executed by a host server with interaction with a user computing device over a network. Some or all of the functionality attributed to a host server may also be implemented on a user computing device.

The method 2100 may include receiving 2102 a brand and/or product selection from one or more players and setting 2104 up a game and the players for the game. The brand/product may be selected by a user or be automatically selected by a computer system performing the method 2100. For example, a brand/product may be selected based on product category received from a user. The manner in which players are assembled and a game is selected and initiated may be according to any of the methods disclosed herein for any of the games disclosed herein, including the use of social media networks to select and invite players for a game. In some embodiments, pairs of players are selected randomly. For example, a player may be matched to another player that has selected the same brand, product, or category of product for a game.

The method 2100 includes selecting 2106 a prompt for the one or more players for a game. The prompt may be selected according to the received 2102 brand and/or product selection. For example, the prompt may include some or all of text, images, video data, and audio data. For example, a short video clip may be the prompt and played back for the players. The content of the prompt may relate to a product of the received 2102 product selection, a product for a received 2102 brand, an intended use of a selected product or product belonging to a selected brand, an advertisement for a selected product or product belonging to a selected brand, or any other content relating to a selected product or brand.

The content for a prompt may be retrieved from a database indexed by product and/or brand and where multiple items of content related to a selected product and/or brand, an item may be selected 2106 at random with reference to items of content that have already been selected 2106 as prompts for the players for which the method 2100 is being executed. In some embodiments, a database of content may be populated by retrieving content from a corpus of documents, such as websites accessible over the Internet. Items of content may be identified using conventional search techniques and added to a database indexed according to one or more of a product, class of products, and brand to which the item of content relate. In some embodiments, the selection 2106 step may invoke searching of websites for content to use as a prompt relating to the selected brand and/or product and an item of content found may be used as the prompt.

The selected 2106 prompt may be transmitted 2108 and displayed to the players, such as to player computing devices. The prompt may be transmitted with data defining an interface, e.g. website or other interface, for receiving a response to a prompt. A response to the prompt may then be received 2110 from the players, such as by receiving an input through an interface on the player computing devices and transmitting the input by the player computing devices to the host server. The responses may be free-form input, e.g. text typed into a text field of finite length. The responses may also be selections of a finite number of items transmitted to the players with the prompt. For example, a prompt may be transmitted with a finite number of letters, e.g. less than the entire alphabet, from which the players can form words. The finite number of letters may include letters forming one or more keywords associated with the prompt. In some embodiments, the players may be given a time limit of X seconds to provide a response.

The similarity among the responses of the players may be evaluated 2112. Where only a finite number of selections are permitted, simple identically of selections may be determined. Where responses are free-form text any method for evaluating textual similarity may be used such as edit distance, a count of identical words or forms of the same root word. In some embodiments keywords may be associated with a prompt. Accordingly, evaluating response similarity may include evaluating whether responses of any of the players included any of the keywords.

Points may be assigned 2114 according to the evaluation 2112 of similarity. This may include one or more of assigning points for words in common among responses, a number of players that included a word common to responses of two or more players, the number of keywords included in a response, and based on any other metric of textual similarity among the responses. In some embodiments, greater points are assigned for matching words between players that are also keywords. The points assigned for matching keywords may also be proportional or otherwise a function of popularity, e.g. frequency of entry, of the matching keywords among previous responses in previous games according to the method 2200 by other players. In some embodiments, a single player may participate in the game. Accordingly, assigning 2114 points according to similarity may be based exclusively on similarity of words received from the single player to keywords associated with the prompt. For single player games, points may be assigned for forming words using a finite number of letters with points assigned according to similarity to keywords and zero or more points assigned for other words formed for words other than the keywords.

The method 2100 may further include assigning 2116 one or both of promotion terms and a product that is a subject of the promotion according to an outcome of the game, such as using points assigned to the players. The method by which a promotion and/or product are assigned and/or redeemed may be according to any of the methods and games described hereinabove. In particular, as for other embodiments, a promotion may have a time limit associated therewith in which it must be redeemed.

The interactive game play of the method 2100 may include various other aspects or variations. For example, hints may be provided to players as to what has been entered by another user, the degree to which non-identical or misspelled words are deemed to match may be lesser or greater (e.g. an edit distance between words), hints related to the selected product and/or brand may be provided to encourage players to provide similar inputs. Points may also earned or purchased and used to buy hints or other helps to ensure similarity to one or both of keywords and responses of other players.

In some embodiments, difficulty may be increased by informing players that certain keywords may not be used. Keywords that are excluded or for which points are awarded if included in a response may be determined by analyzing past games, e.g. past responses of other players with respect to the same prompt or prompt in a same category. In some embodiments, analysts according to human judgment may determine keywords for assigning bonuses or for exclusion.

The method 2100 may also be executed in an iterative manner such that players with N points, or N matching words, are able to advance to subsequent rounds. The criteria for advancing to the next round may increase with each round, e.g. the number of points N or matches N, required to advance to a next round. Likewise, the amount of time allowed to type a response may be reduced with each round. A game may end when no player meets the threshold for the current round. Each iteration may include repeating some or all of steps 2106-2116.

The responses of players to the prompts may reveal information about how the players perceive a product and/or brand. Accordingly, the responses may be archived 2118 for subsequent analysis. Once a large enough number of responses have been received with respect to a product and/or brand (which may include a single response or several hundred), these responses may be analyzed 2120 with respect to advertising for the product and/or brand. For example, the occurrence of words or sentiment with respect to a brand and/or product may be compared with content of advertising for that brand and/or product. For example, advertising may seek to communicate attributes of a product. Evaluating 2120 responses with respect to advertising may include evaluating how many responses associate one or more of these attributes with the brand.

Responses may also be to characterize 2122 consumer awareness, either with respect to advertising content or based only on responses themselves. For example, a number of occurrences of words or phrases may be compiled. The top N words with the highest frequency of occurrence may be used to characterize consumer awareness. When counting words, plural versions of the same word may be counted as the same word. Likewise, synonyms may also be counted as the same word as are words based on the same root or otherwise substantially identical.

Data obtained according to the evaluation 2120 and characterization 2122 may be stored for later use and/or transmitted to a representative of a merchant or retailer and displayed on a computing device. Keywords identified for a brand, product, image, text, or other data relating to a prompt for players may be used for various purposes, such as to show aided or unaided recall of brand advertising copy, identifying keywords for search engine optimization, or other purposes. User responses with respect to an image could also be used on a dating site. Other users may input text in response to an image of a first user and these words could then be associated with the profile of the first user, after filtering out any offensive or inappropriate keywords. In this manner, a more nuanced rating system is implemented.

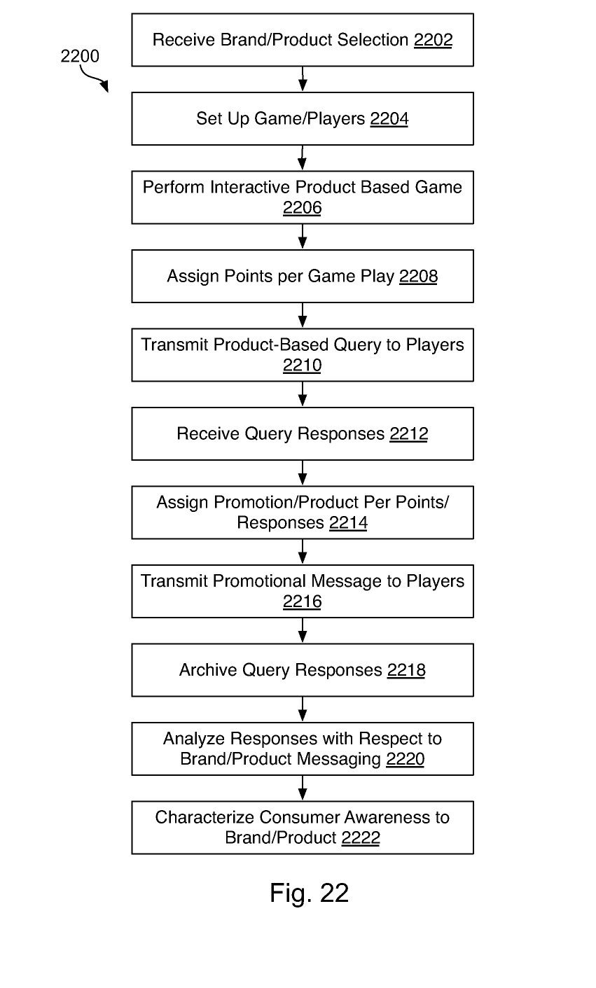

FIG. 22 illustrates an alternative method 2200 for gathering information about user perceptions of products and brands using a product-based game. The method 2200 may be executed by a host server with interaction with user computing device of players. Some or all of the functionality of the host server may also be implemented on a user computing device. The method 2200 may include receiving 2202 a selection of a brand, product, or category of products, setting 2204 up a game and adding players to a game, performing 2206 an interactive product based game, and assigning 2208 points according to game play. Steps 2202-2206 may include any of the approaches to these steps described in this application. In particular, the product-based game may include any of the product-based games described herein.

At some point during or after performing 2206 interactive game play, a product-based query may be transmitted 2210 to some or all of the players participating in the interactive game, such as by transmitting the query to computing devices operated by some or all of the players. The product-based query may relate to a received 2202 product, received 2202 brand, or a class of products relating to a received 2202 selection. The queries may be generated by a manufacturer or retailer and may be stored in a database indexed by some or all of brand, product, and product category. The queries may include options selectable by a user or may be open-ended such that a user may respond with free-form text.

In response to the transmitted 2210 queries, the players may return responses that are then received 2212 by the host server. For example, the query may be received by user computing devices of the players, which then display the query. Responses to the query are then received from the players by the user computing devices that transmit responses to the host server.

The method 2200 may further include assigning one or both of a product and a promotion to one or more player according to the interactive game play at step 2206 and responses received 2212. For example, a player may be assigned a first promotion or points according to game play. An additional promotion or an enhanced promotion may then be assigned to the player as a reward for providing a response. In some embodiments, the number of points redeemable to obtain promotions may be augmented according to any response received 2212 from the player. Where a player is not entitled to a promotion based on game play, the player may be assigned points, a product, and/or a promotion based on the player providing a query response. Promotional messages may be transmitted 2216 to the players participating in the method 2200 indicating the promotion and/or product in the same manner as for other methods described herein.

The received responses may be some or all of the players may be archived 2218, analyzed 2220 with respect to brand and/or product messaging, and used to characterize 2222 consumer awareness with respect to a brand and/or product in the same manner as for the method 2100.

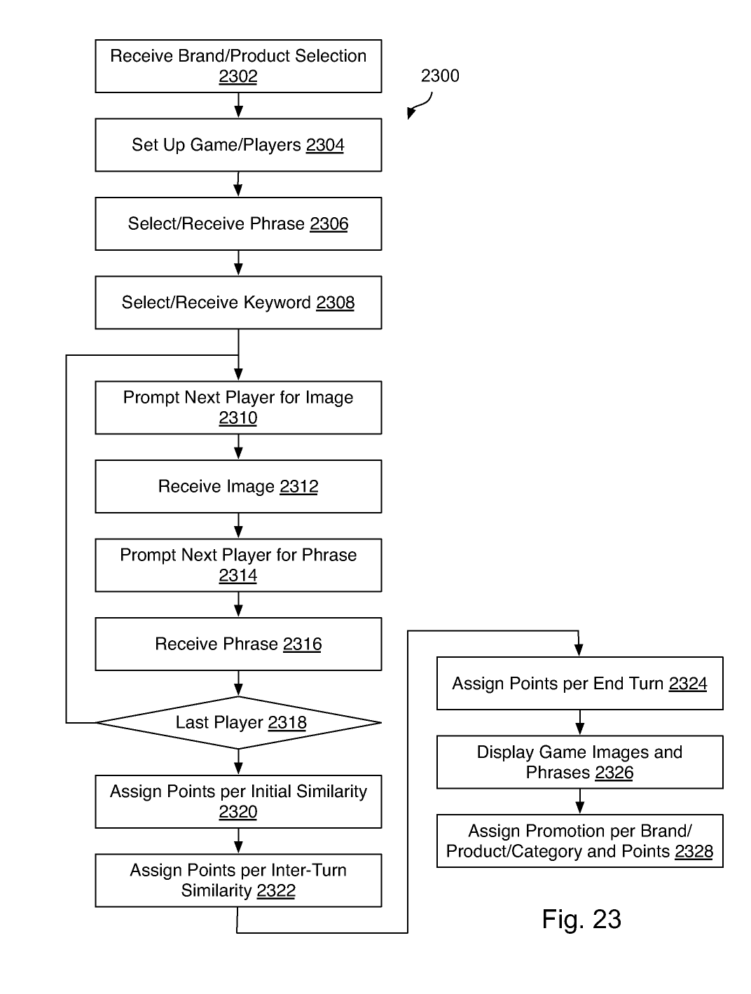

FIG. 23 illustrates a method 2300 for providing a product-based game. The method 2300 may be executed by a host server with interaction with a user computing device over a network. Some or all of the functionality attributed to a host server may also be implemented on a user computing device.

The method 2300 may include receiving 2302 a selection of one or more of a product, brand, and class of products and setting 2304 up the game and players for the game. The manner in which the selection step 2302 and set up step 2304 are performed may be according to any of the other methods and games described herein.

The method 2300 may further include selecting 2306 or receiving a phrase. The phrase may be automatically selected by the computer system executing the methods 2300 based on the received 2302 selection, e.g. a phrase relating to an attribute, use, advertising copy, abstract concept, or other aspect of the received 2302 selection. In some embodiments, the phrase is not necessarily relevant to the received 2302 selection. The phrase may also be received from one or more players for which the method 2300 is being performed, such as a player that initiated the game. That nature of the phrase can determine the difficulty of the game. Where the phrase is merely descriptive of an object, person, activity, or the like, the game may be relatively easy. Where the phrase is more abstract in the ideas it communicates, the game may be more difficult.

In some embodiments, one or more keywords may be selected 2306 or received. The keywords may be selected 2308 from the words comprising the phrase from step 2306. The keywords may be automatically selected or specified in a record storing the phrase. For example, a database of phrases may be stored and may be indexed according to a brand, product, or category of products to which the phrase corresponds. A record for a phrase may also record one or more keywords from the phrase that are considered important. The keywords may also be automatically determined such as using natural language processing (NLP) to identify important parts of a phrase, e.g. subject noun, verb, direct object, etc. Where the phrase and/or keywords are selected by a player, this may be this player's turn in the game.

The method 2300 may then proceed with turns of the game. The next player may be prompted 2310 to select an image, such as by transmitting a prompt to select an image to a user computing device associated with the next player. The prompt may include the phrase from step 2306 and text instructing the player to select an image corresponding to the phrase. The prompt may include a collection of images from which the player can select an image or an interface element for invoking display of a collection of images to choose from. Alternatively, the player may select any image stored on the player's computing device or retrieved from a website accessible over the internet.

The player's selection may then be received 2312, either by receiving an upload of an image from the user computing device or by receiving an identifier of an image, such as an image from a collection presented to the user on the user computing device. In some embodiments, inappropriate images may be filtered such as by comparing received images to a collection of known offensive image or comparing a URL associated with an image with a blacklist of URLs known to host inappropriate content.

The method 2300 may then include prompting 2314 a subsequent player (e.g. a different player from the previous player prompted at step 2310) to provide a phrase. This may include transmitting a prompt to a user computing device of the subsequent player. The prompt for the subsequent player may include the image received at step 2312 from the previous player and may also include an instruction to enter a phrase corresponding to the image. A phrase may then be received from the prompted 2314 player, such as receiving a phrase typed into a user computing device of the prompted player and transmitted from the user computing device of the prompted player to the host server.

In some embodiments, the game of the method 2300 may proceed indefinitely, with multiple pairs of players alternatively entering images and phrases in response to phrase and image prompts. For example, the player for steps 2314 and 2316 and/or the player from steps 2310-2312, may invite one or more players to take a turn. Inasmuch as each round requires two players (one to select an image and another to enter a phrase), the player may be required to obtain acceptances from two players, or some other number, in order to invoke another iteration of steps 2310-2316. The player may solicit other players by means of text message, email, within a social media forum. Solicitations may include sufficient information to enable the player to join the game, such as a web address to obtain an interface for receiving prompts and providing images and/or phrases.

If the player at steps 2314-2316 is not found 2318 to be the last player, the method 2300 may include repeating steps 2310-2318 with respect to additional players. In some embodiments, a game according to the method 2300 may have a time limit associated therewith, such as a predefined time limit according to game logic or a time limit specified by an initiating player or otherwise agreed on by two or more of the players. In such instances, a game may be found 2318 to have ended when this time limit is reached.

If the last player is found 2318 to have taken a turn, then one or more of steps 2320-2328 may be executed to assign points according to game play. In some embodiments some or all of steps 2320-2328 are executed after player turns but before the end of the game in order to assign points based on actions taken during the turn.

Points may be assigned for various aspects of game play. In some embodiments, points are assigned to teams of players each a player that entered an image and a player that input a phrase in response to the image. For example, points may be assigned 2320 according to initial similarity, e.g. the similarity of a phrase input by a team and the initial phrase selected 2306. Evaluating similarity may include any metric of textual similarity. As noted above, one or more words may be identified as keywords in the initial phrase, accordingly points may be assigned, e.g. bonus points, where a word in a phrase entered by a team matches a keyword. Points may also be assigned for words in a phrase entered by a team that match the initial phrase. A word in an entered phrase may be deemed to match a word in an initial phrase if it has the same root word or has an edit distance score indicating a high degree of similarity. Points may also be assigned according to word proximity and/or word ordering, i.e. if two or more words in an entered phrase have the same proximity or ordering as these same words in the initial phrase, points may be assigned according to this similarity.

The method 2300 may further include assigning 2322 points according to inter-turn similarity. For example, a phrase entered by a team in one iteration of steps 2310-2316 may be compared to a phrase entered by another team in a different iteration, e.g. an immediately following iteration or other iteration. The similarity between phrases entered by different team may be evaluated in the same manner as similarity is evaluated with respect to an initial phrase with points assigned according to similarity in the same or different manner.

In embodiments, points may be assigned 2324 according to which team was the last to take a turn. For example, where the last team can solicit invitations for other players to join, a penalty may be assigned to the last team. Where the game ends based on a time limit, the last team to take a turn may be assigned bonus points.

In some embodiments, some or all of the phrases and images selected based thereon may be displayed 2326 to participating players, such as by transmitting the collection of images and phrases to computing devices of the participating players. Based on the points assigned to the players, a promotion and some or all of a product, brand, and product category may be assigned 2328 to the players based on the outcome of the game in accordance with any of the methods described hereinabove.

In some embodiments, some or all of phrases entered in response to images and images selected in response to phrases may be collected and used to characterize customer awareness with respect to a product, brand, advertising campaign, or the like, as for the methods 2100 and 2200.

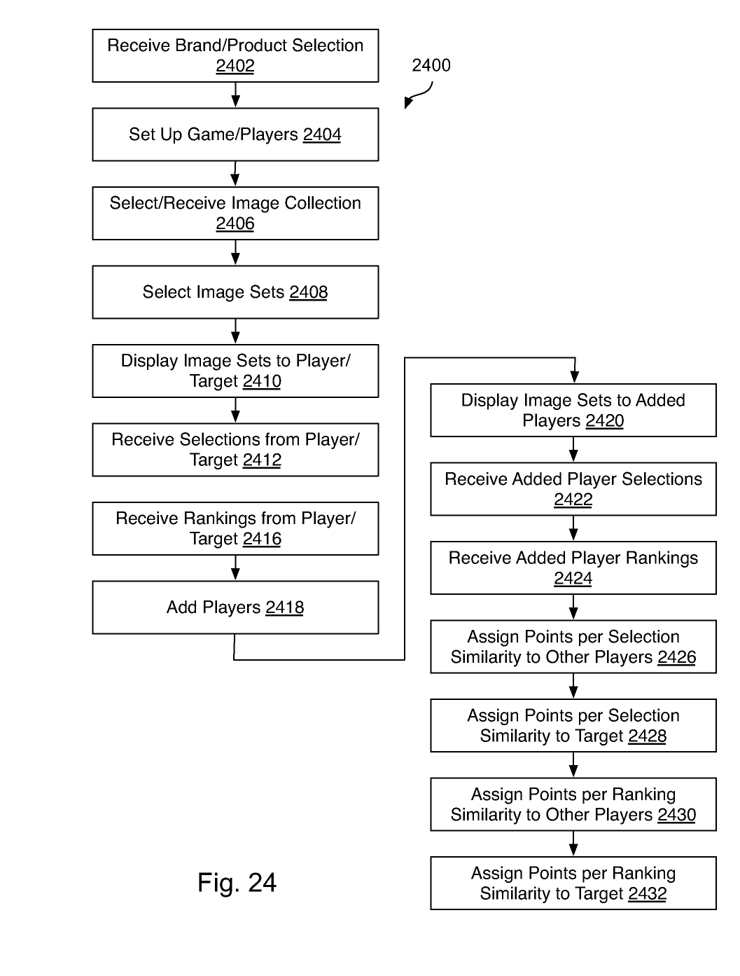

FIG. 24 illustrates a method 2400 for playing an image game. The method 2400 may be executed by a host server with interaction with a user computing device over a network. Some or all of the functionality attributed to a host server may also be implemented on a user computing device.

The method 2400 may include receiving 2402 a selection of one or more of a product, brand, and class of products and setting 2404 up the game and players for the game. The manner in which the selection step 2402 and set up step 2404 are performed may be according to any of the other methods and games described herein.

The method 2400 may include selecting 2406 an image collection, such as an image collection corresponding to the selection 2402. Alternatively, an image collection may be selected by a player, such as an initiating player. The image collection may be selected automatically based on a category or other classifier of the subject matter of images specified by a player. The image collection may also be retrieved or received from social networking data of a player.

Sets of images from the collection may then be selected 2408. For example, groups of three or other number N of images may be selected. The images of the image set are then displayed 2410 to the player and target, such as by transmitting the image set to computing devices of the players. The images may be transmitted with data defining an interface whereby the players can input a selection and/or ranking of some or all of the images of the set.

Then a plurality of image sets may then be displayed 2410 to at least one player and a target, such as by transmitting the image sets to computing devices associated with these individuals. A selection of at least one image from each set of images may be received 2412 from each of the at least one player and the target, such as by receiving identifiers of images or images themselves from computing devices associated with these individuals. In some embodiments, the selections from the target are received 2412 prior to receiving selections from the at least one player. In some embodiments, the target and the one or more players may be displayed the same images, but organized differently, e.g. different sets of images and/or different arrangement, in order to prevent collusion.

In some embodiments, rankings may be received 2416 from the at least one player and the target, such as from computing devices associated therewith. The rankings for an individual target or player may be an ordering of the selected images received 2412 from that individual for the image sets displayed to the individual. As for the step 2412, the target may rank the selected images prior to the one or more players or vice-versa.

In some embodiments, the game may end and points may be assigned after the target and one or more players provided image selections and rankings. In others, the game may continue by adding 2418 more players. For example, the target and/or one or more players may solicit other players to join the game, such as by invoking, from user computing devices, transmission of invitations to one or more additional players. The invitation may include a link or other information enabling the one or more additional players to join the game.

If players are added, then the method 2400 may include displaying 2420 sets 2420 of images to the additional players in the same manner as for the target and original at least one player, which may include the same images shown to the target and player with a same or different groupings into stets. For each additional player, selections for each image set shown to the additional player may also be received 2422 in the same manner as for the target and original at least one player. Likewise, rankings of the images selected by each additional player may also be received 2424 from each additional player in the same manner as for the target and original at least one player. The steps 2418-2424 may be repeated as additional player successfully solicit other players to join the game.

When a game ends, e.g. the target and all of the original at least one players have provided image selections and rankings and any additional players have provided image selections and rankings, points may be assigned to some or all of these participants. In some embodiment, a game ends upon expiration of a time limit.

For example, points may be assigned 2426 according to similarity between the selections of the original at least one player and one or more additional players. For example, a player may be assigned one or more points that increases with both the number of images selected by the player that were selected by one or more other players and the number of other players that also selected the same image.

The method 2400 may further include assigning 2428 points to players according to similarity of the players' image selections and those of the target. The game for a method 2400 may be played with respect to the target that is preferably known to the players. The selection of images by the players may be with a goal of matching the selections of the target and prompts to select images, invitations to join games, or other messages displayed to the players may identify the target and indicate that selections should be made with respect to the target. Prompts to select images may identify the target. Accordingly, each player may be assigned 2428 points according to a number of images selected by the player that were also selected by the target.

The method 2400 may further include assigning 2430 points to each player according to similarity of the ranking of the player to that of other players. Points may be assigned for identicality of ranks associated with identical images: e.g. a point if image A for player 1 has rank N and image A of player 2 also has rank N. Points may additionally or alternatively assigned for similarity of relative rankings: player 1 ranks image A higher than image B and player 2 ranks image A higher than image B, so points will be assigned for this to players 1 and 2 for this reason. Points may also be assigned 2432 according to ranking similarity of players with respect to the target in the same manner but with the same or different point assignments according to similarity.

In some embodiments, points assigned according to selection similarity to other players, ranking similarity to other players, selection similarity to the target, and ranking similarity to the target may be augmented, decremented, or scaled according to the time it took a player to one or both of select images and rank images. The points for a user may be scaled or otherwise adjusted according to an aggregate time spent in selecting and ranking images. Alternatively, points associated with a specific image may be adjusted or scaled according to the time spent by a player between display of a set of images including the image and selection of the image by the player. Likewise, point assigned according to ranking may be scaled or otherwise adjusted according to a total time in assigning a ranking to the images or a time spent in assigning a rank to each image, e.g. the time spent after commencement of the ranking step and assigning a ranking to a first image and the time spent between a previous ranking and assigning a rank to other images. Points assigned according to the method 2400 may be used to assign 2432 a product and/or promotion or otherwise redeemed according to methods disclosed herein and any of the other games disclosed herein. A target player may additionally or alternatively be assigned points according to the number of players that participate in a game with respect to the target.

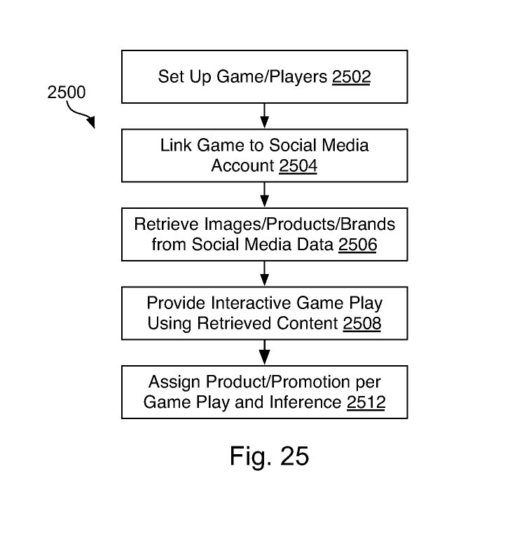

FIG. 25 illustrates a method 2500 for playing a product-based game integrated with social media content of a user. The method 2500 may be executed by a host server with interaction with a user computing device over a network. Some or all of the functionality attributed to a host server may also be implemented on a user computing device.

The method may include setting up 2502 a game and the players for a game, such as using any method here for assembling players and initiating a game described herein in order to play any game disclosed herein, or some other game. The method 2500 may further include linking 2504 or otherwise associating the game with at least one social media account, such as one or more social media accounts of the one or more players for the game. In some embodiments, where a player invokes a game from within a social media interface, the player's account may be linked 2504 as a part of this action, e.g. the game interface may operate in the context of the player's account either on the player's computing device, a server system operated by a provider of the social media interface, and a host server providing product-based games in accordance with the methods described herein. Linking may also include providing authentication information or access privileges sufficient to enable a provider of a product-based game in accordance with the embodiments disclosed herein to access a social media account of the player.

The method 2500 may further include retrieving 2506 content, such as product-based content, from the linked 2504 social media account. This may include retrieving images included in the social media account or referenced by links in the social media content. Textual and image content may also be analyzed to identify some or all of references to products, brands, classes of products, or activities that are performed using products. These references may be used to extract some or all of a brand, product, or class of products for use in providing a product-based game according to any of the games disclosed herein. In some embodiments, a user may additionally or alternatively expressly select a brand, product, or category products in the same manner as for other embodiments disclosed herein.

The method 2500 may further include providing 2508 interactive game play using one or both of 1) a brand, product, or category of products inferred from the social medial content and 2) actual images included in the social media content or referenced by links in the social media content. For example, in many of the games disclosed herein, a game is played using images of products as interface elements. Accordingly, images retrieved from social media content may be used in this manner.

Some or all of points, a specific product, and a specific promotion terms, may be assigned 2512 according to the interactive game play in the same manner as for any of the methods and games described herein. In particular, a brand, product, or product category preference, used in selecting a product for a promotion may be performed using a brand preference inferred from the retrieved 2506 social media content, including analysis of some or all of images, uniform resource locators (URLs) associated with images, references to brand, products, product categories, or activities relating to products or product categories within the social media content.

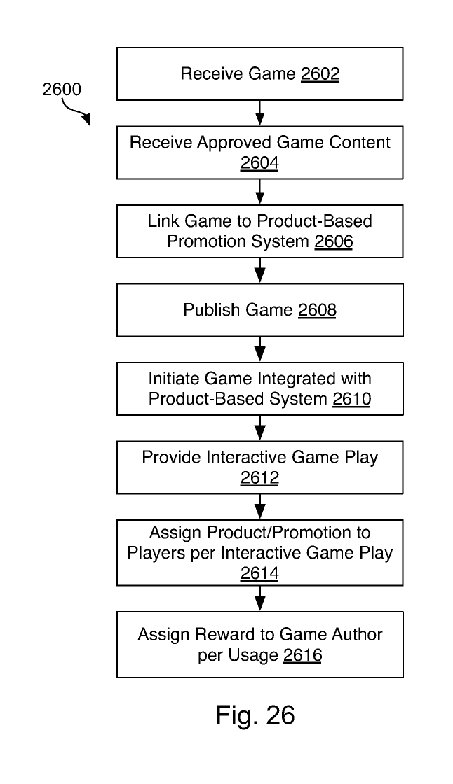

FIG. 26 illustrates a method 2600 that may be used to integrate games of various authors into a product-based gaming system, such as product-based gaming systems disclosed herein. The method 2600 may be performed by a server system providing product-based games, such as product-based games in accordance with the methods disclosed herein.

The method 2600 may include receiving 2602 a game from an author. Receiving 2602 a game may include receiving computer code sufficient to define the game logic or a link or interface for accessing the logic of the received 2602 game. The game may be received by an entity providing product-based games, such as by means of a host server providing product-based games as described herein.

The method 2600 may further include receiving 2604 content for use in playing the received game. In particular, receiving 2604 content may include receiving images that may be used as game interface elements for the received 2602 game. For example, product images may be used as interface game elements similar to some or all of the games disclosed herein. In some embodiments, content will be vetted before approved for use in accordance with the method 2600. In some embodiments, this may be accomplished by accepting content only from sources that perform vetting of content, such as content that has previously been approved for posting by a social media forum. Vetting may include evaluating the appropriateness of content as well as the legal right of the game author to use the content.

The method 2600 may further include linking 2606 the received 2602 game to a product-based gaming system. As described hereinabove, games may have an initial step where a product, brand, or product category is associated with a game, such as due to selection thereof by one or more players. Likewise, as described herein above, game interface elements corresponding to this selection may be integrated into game player. In the above described methods, promotions and products may also be assigned according to the selection. Accordingly, linking 2606 the received game with the product based system may include plugging in the logic and interface of the received 2602 a game into any of the methods described herein as the interactive game provided to players for purposes of assigning points to be subsequently used to determine a promotion and or product that is the subject of the promotion in accordance with the methods described herein. Linking may also include inserting advertisements or other branded content into the interface for the received 2602 game.

Linking the game may include providing an interface element for invoking playing of the game in an interface providing access to product-based games by a host server. Additionally or alternatively, linking may include providing a link or interface to the author from which the game was received in order to enable invoking of the product-based methods described herein with game logic according to the received 2602 game.

The method 2600 may include publishing 2608 the game. For example, in some embodiments games according to embodiments disclosed herein may be accessed through a social media site. A link or interface element in the social media site may invoke either type of linked game: a game provided by an entity providing product based games that links to the received 2602 game or a game provided by the author and accessing product-based functionality from the entity providing product-based games.

Players or groups of players may initiate 2610 games according to the received 2602 game according to any of the methods disclosed herein including adding players to a game using social media content. Where an interface element for invoking the game is provided in a social media forum, initiating of a game may be invoked by user interaction with this element.

The method 2600 may then include providing 2612 interactive game play according to both product-based methods disclosed herein and the received 2602 game. For example, this may include initiating a product-based game as for the methods disclosed herein, including selecting or receiving selection of a brand, product, or categories of product and assembling players as described herein. In some embodiments, rather than receiving a product-based selection such as a product or brand, game play may proceed using the received 2604 game content as game interface elements in the same manner as game interface elements selected based on a product-based selection according to the methods disclosed herein. The game play and game interface for the players and according to the product selection may then be provided according to the received 2602 game. Based on the game play, a product and/or a promotion may be assigned 2614 to players of the game according to the methods disclosed herein. In embodiments where the received 2604 game content is used, a product and/or promotion may be assigned by first inferring from the game content a product, brand, or category of products that related to the received 2604 game content. For example, where the content includes family photos of children, the promotion may be for child care products, toys, or other products of interest to a parent or children. In another example, where the content includes images of dogs, a promotion may be assigned for pet care products such as dog bed, dog toys, dog leashes, or the like.

The method 2600 may include the additional step of assigning a reward to an author of the received 2602 game. A reward for the author may exist separately from rewards to players and such that they may or may not be able to be aggregated together and redeemed. A reward may be in the form of points determined as a function of a number of players that play the received 2602 game. A reward may additionally or alternatively be a function of a number of products purchased by players as a result of the game, e.g. redemption by players of promotions assigned according to the game upon purchasing a product according to the promotion. Rewards may also be assigned to one or more metrics of popularity, such as a number of playing of the received 2602 game in a time period (e.g. since the last assignment of a reward), a number of “likes” of the received 2602 on Facebook™ or a number of references to the received 2602 game in a social media forum, or some other metric of popularity. Rewards assigned 2616 may have inherent value, such as money rewards, or may be redeemable for products, promotions for products, money, or some other thing of value. Rewards may be assigned 2616 by associating the rewards with an account of the author.

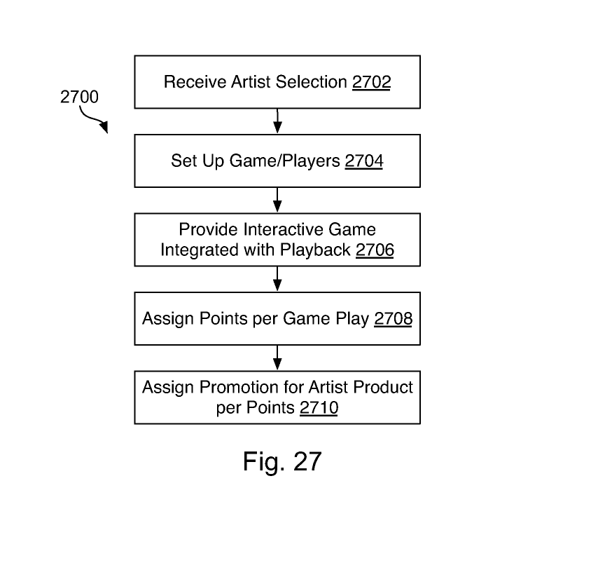

FIG. 27 illustrates a method 2700 for providing a product-based game using musical recordings or products associated with a recording artist. The method 2700 may be executed by a host server with an interface provided on a user computing device. Some or all of the functionality attributed to a host server may also be implemented on a user computing device.

The method 2700 may include receiving 2702 from one or more players a selection of an artist, such as a recording artist. The method 2700 may further include setting up 2704 a game and the players according to any methods described herein for assembling one or more players for a game and initiating a game.

The method 2700 may further include providing 2706 an interactive game integrated with playback of a song from the selected 2702 recording artist. Various examples of such games are known in the art, such as Rock Band™, Guitar Hero™, Dance Dance Revolution™, and the like. For example, in one example, a user may be prompted to tap static or dynamic interface elements along with the rhythm of a song with points assigned for accuracy. The interactive game may include prompting and receiving any action that is synchronized, or rewarded for synchronicity, with playback of the song from the recording artist.

As for other methods described herein, points may be assigned 2708 according to game play and a promotion and or product may be assigned 2710 in the same manner as for other methods described herein. In particular, the promotion assigned may be for a product associated with the received 2702 artist selection, such as a recording or other products associated with the artist such as clothing or other products bearing the artist's name, likeness, or otherwise associated with the artist.

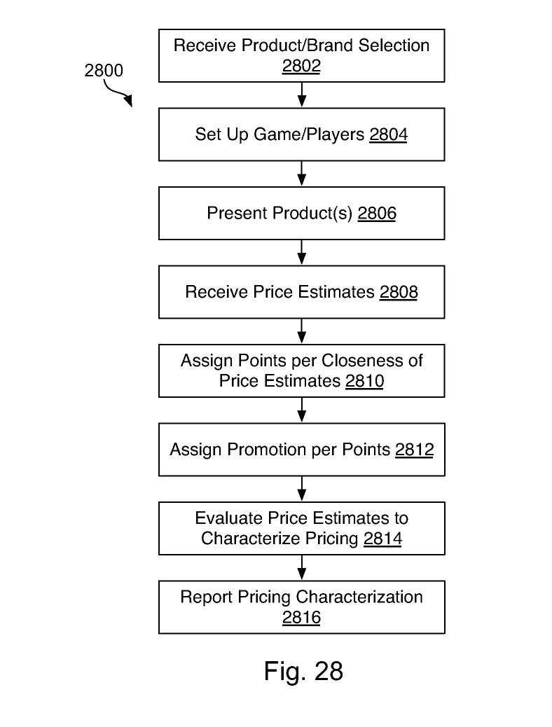

FIG. 28 illustrates a method 2800 for providing a pricing product-based game. The method 2800 may be executed by a host server with an interface provided on a user computing device. Some or all of the functionality attributed to the host server may also be performed on the user computing device.

The method 2800 may include receiving 2802 selection of one or more of a brand, product, or product category and setting up 2804 a game and the players for a game in the same manner as for any of the games disclosed herein.

The method may then include presenting 2806 products to the one or more players. Presenting 2806 may include transmitting an image of the product to the one or more players. Presenting 2806 may additionally or alternatively include transmitting a textual description of a product or functionality of a product. The method 2800 includes receiving 2808 the one or more players price estimates for each of the presented 2806 products. The price estimate may represent an estimate of a suitable purchase price for the presented 2806 products.

Points may then be assigned 2810 according to the price estimates. The products presented may be hypothetical products, product concepts, or products that are otherwise not yet offered for sale. Accordingly, players are not able to simply look up the price. Points may be assigned according to closeness of the price estimates to prices associated with the presented 2806 products. The prices may be assigned by a provider of the game or by a provider of the product specification, such as a prospective manufacturer or inventor of the product. The price may be determined according to human judgment and may be based on an estimate of a cost of manufacture and distribution as well as the value of the product to consumers. The number of points assigned maybe inversely proportional to a difference between a received 2808 price estimate for a presented 2806 product corresponding thereto.

In some embodiments, points may additionally or alternatively be assigned according to a difference between a received 2808 price estimate for a presented 2806 product and an average price estimate for a plurality of price estimates received from a plurality of other players. The other players may be players playing a game with the player or players that have played the game in the past. In the same manner as for other embodiments disclosed herein, a promotion and/or product may be assigned 2812 according to the outcome of the game, such as according to the assigned points.

The price estimates received 2808 for a particular presented 2806 product may be used to obtain information about consumer attitudes and perceptions of the presented product. For example, price estimates 2808 for a presented 2806 product may be evaluated 2814 to characterize 2814 consumer perceptions of a suitable price for the presented 2806 product. This information may be reported 2816to an interested party, e.g. transmitted to a computing device of the interested party. The interested party may be the party that submitted the presented 2806 product for use in the game, such as a prospective manufacturer, designer, potential investor, potential retailer, or some other interested party.

In the foregoing application various games have been described. The game logic incorporated into the product-based games disclosed herein may include various other games known in the art. For example, various tile-based games such as Mah-Jong, Dominoes, or the like. The tiles of these games may include images of products associated with a product-based game as disclosed herein. Another tile-based game may be a matching game wherein an array of tiles is presented. A player may swap adjacent tiles along a vertical or horizontal direction in order to achieve three (or more) identical tiles in a row. The identical tiles are then removed and points assigned, such as according to the number of matching tiles. Tiles may then be moved down to occupy the position of the removed tiles and the game may continue.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The software code may also include scripting languages such Pearl, Python, PHP, and the like. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention, this is used for transitive and non-transitive storage. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state during transitive and non-transitive storage. The invention is not limited to any particular type of memory device, or any commonly used protocol for storing and retrieving information to and from these memory devices, respectively.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

What is claimed is:

1. A method for product-based gaming, the method comprising:
receiving, by a computer system, a game interface from a contributor computing device associated with a contributor;
receiving, by the computer system, a product-based selection from at least one player;
interacting, by the computer system, with the at least one player to provide interactive game play having at least one element of the game interface corresponding to the product-based selection;
assigning, by the computer system, at least one first promotion to the at least one player relating to the product-based selection, the at least one promotion determined in accordance with the interactive game play; and
assigning, by the computer system, at least one second promotion to the contributor.

2. The method of claim 1, further comprising, integrating the game interface into a product-based game interface.

3. The method of claim 1, further comprising integrating one or more product-based elements into the game interface according to the product-based selection.

4. The method of claim 1, wherein assigning at least one second promotion to the contributor further comprises:
assigning the at least one second promotion according to redemption of the at least one first promotion.

4. The method of claim 1, wherein assigning at least one second promotion to the contributor further comprises:
assigning the at least one second promotion according to popularity of the game interface.

5. The method of claim 4, wherein popularity is determined according to a number of playings of the game interface.

6. The method of claim 4, wherein popularity is determined according to a number of likings of the game interface in a social media forum.

7. The method of claim 1, further comprising providing, by the computer system to the contributor computing device, an interface element effective to invoke a product-based interface integrated with the game interface.

8. The method of claim 1, further comprising, receiving from the contributing computing device game content for use with the game interface.

9. The method of claim 1, wherein the product-based attribute is a brand.

10. The method of claim 1, the product-based attribute is a product.

11. A method for product-based gaming, the method comprising:
receiving, by a computer system, a game interface from a contributor computing device associated with a contributor;
generating, by the computer system, a product-based interface configured to invoke the game interface;
receiving, by the computer system, a product-based selection from at least one player using the product-based interface;
interacting, by the computer system, with the at least one player to provide interactive game play having at least one element of the game interface corresponding to the product-based selection, the interactive game play performed using the game interface;
assigning, by the computer system, at least one first promotion to the at least one player relating to the product-based selection, the at least one promotion determined in accordance with the interactive game play; and
assigning, by the computer system, at least one second promotion to the contributor.

12. The method of claim 1, further comprising permitting, by the computer system, redemption of aggregations of first promotions and not permitting redemption of aggregations of first and second promotions.

13. The method of claim 1, wherein the at least one second promotion includes cash.

14. The method of claim 1, wherein assigning at least one second promotion to the contributor further comprises:
assigning the at least one second promotion according to redemption of the at least one first promotion.

15. The method of claim 1, wherein assigning at least one second promotion to the contributor further comprises:
assigning the at least one second promotion according to popularity of the game interface.

16. The method of claim 15, wherein popularity is determined according to a number of playings of the game interface.

17. The method of claim 15, wherein popularity is determined according to a number of likings of the game interface in a social media forum.

18. The method of claim 11, further comprising providing, by the computer system to the contributor computing device, an interface element effective to invoke the product-based interface.

19. The method of claim 11, further comprising, receiving from the contributing computing device game content for use with the game interface.

20. The method of claim 19, wherein the game content is a collection of images.

21. A method for product-based gaming, the method comprising:
receiving, by a computer system, a game interface from a contributor computing device associated with a contributor;
receiving, by the computer system, game content associated with the contributor;
interacting, by the computer system, with the at least one player to provide interactive game play having at least one element of the game interface corresponding to the game content;
identifying a product-based attribute corresponding to the game content; and
assigning, by the computer system, at least one first promotion to the at least one player relating to the product-based attribute, the at least one promotion determined in accordance with the interactive game play; and
assigning, by the computer system, at least one second promotion to the contributor.
